(19) United States
(12) Patent Application Publication
(10) Pub. No.: US 2008/0165722 A1
(43) Pub. Date: Jul. 10, 2008

(54) RADIO COMMUNICATION SYSTEM ALLOWING RADIO COMMUNICATION WITH REDUCED LOAD

(75) Inventors: Bing ZHANG, Koganai-shi (JP); Kenichi MASE, Niigata-shi (JP); Hiraku OKADA, Niigata-shi (JP); Masanori NOZAKI, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: National Institute of Information and Communications Technology, Tokyo (JP); Oki Electric Industry Co., Ltd., Tokyo (JP)

(21) Appl. No.: 11/969,552

(22) Filed: Jan. 4, 2008

(30) Foreign Application Priority Data
Jan. 5, 2007 (JP) 2007-000343

(51) Int. Cl. H04B 7/14; H04Q 7/24

(52) U.S. Cl. 370/315; 370/338

(57) ABSTRACT

A radio communication system includes a plurality of radio devices and a plurality of terminal devices. The plurality of radio devices forms a mesh-type radio network. A plurality of terminal devices belong to a radio device and another plurality of terminal devices belong to another radio device. The plurality of radio devices each have global terminal connection information representing the connection between the terminal devices and the radio devices in the entire radio communication system. A radio device and another radio device relay radio communication between a terminal device and another terminal device using the global terminal connection information. When any of its subordinate terminal devices changes, each of the plurality of radio devices floods only the change information in the radio communication system.

### BACKGROUND OF THE INVENTION

1. Field of the Invention

The present invention relates to a mesh-type radio communication system, and more specifically, to a radio communication system that can operate with a reduced load.

2. Description of the Related Art

The ad hoc network is constructed autonomously and instantaneously by mutual communication between a plurality of radio devices. In the ad hoc network, if two communicating radio devices are not present in each other's communication areas, a radio device positioned between the two radio devices functions as a router to relay data packets, and therefore a wide range multi-hop network can be formed.

Dynamic routing protocols that support multi-hop communication include table-driven protocols and on-demand protocols. The table-driven protocols allow control information related to routes to be regularly exchanged, so that a routing table is previously set, and known examples of the protocols include FSR (Fish-eye State Routing), OLSR (Optimized Link State Routing), and TBRPF (Topology Dissemination Based on Reverse-Path Forwarding).

The on-demand protocols allow a route to a destination to be made only when a demand for data transmission is issued, and known examples of the protocols include DSR (Dynamic Source Routing) and AODV (Ad Hoc On-Demand Distance Vector Routing).

Recently, RA-OLSR (Radio Aware Optimized Link State Routing) based on the OLSR protocol and depending on the Fisheye scope has been defined as a protocol that allows the period for exchanging a control message to be changed in IEEE802.11s draft (D-1.0) (IEEE P802.11s/D1.00, November 2006).

The RA-OLSR protocol is directed to a network including a plurality of MAPs (Mesh Access Points) arranged in a mesh state and a plurality of STAs (Stations) subordinate to each MAP.

In the RA-OLSR protocol, each MAP produces an LAB (Local Association Base) representing the connection between itself and its plurality of subordinate STAs and transmits the produced LAB to all the MAPs.

Then, each MAP produces a GAB (Global Association Base) representing the connection between the MAPs and STAs in the entire network based on the LAB produced by itself and those received from the other MAPs.

Upon receiving a transmission packet from one of its subordinate STAs, each MAP searches for the forwarding point for the packet (MAP) on the way to transmit the received packet to the destination STA based on the GAB.

### BRIEF SUMMARY OF THE INVENTION

However, in the conventional RA-OLSR protocol, the plurality of MAPs that form the network periodically update the LABs and flood them, which increases the load in the entire network.

Upon updating its own LAB, a certain MAP calculates a checksum of the updated LAB and transmits the resulting checksum to all the MAPs in the network. Upon receiving the checksum, the plurality of MAPs transmit a transmission request for the updated LAB to the source MAP, and therefore transmission requests for the LAB concentrate in the source MAP.

When a new MAP joins the network, the new MAP should receive LABs transmitted from all the plurality of MAPs existing in the network, which increases the load in the entire network.

In this way, when the conventional RA-OLSR protocol is used, the load in the entire network increases.

The invention is directed to a solution to this disadvantage, and it is an object of the invention to provide a radio communication system that allows radio communication with a reduced load.

According to the invention, a radio communication system includes a first radio device, a first terminal device, a second radio device, and a second terminal device. The first terminal device is connected with the first radio device. The second terminal device is connected with the second radio device. The first and second radio devices construct terminal connection information representing the connection between the radio devices and the terminal devices as required and relay radio communication between the first terminal device and the second terminal device.

Preferably, upon receiving a packet destined to the second terminal device from the first terminal device, the first radio device obtains local terminal connection information representing the connection between the second radio device and the second terminal device and relays the packet to the second radio device based on the obtained local terminal connection information, and the second radio device receives the packet relayed by the first radio device and transmits the received packet to the second terminal device. The second terminal device receives the packet transmitted from the second radio device.

Preferably, upon receiving the packet from the first terminal device, the first radio device floods a terminal information request that requests the transmission of the local terminal connection information and receives the local terminal connection information from the second radio device by unicast.

Preferably, the radio communication system further includes a third radio device. The third radio device relays radio communication between the first radio device and the second radio device. Upon receiving the packet from the first terminal device, the first radio device floods a terminal information request that requests the transmission of the local terminal connection information and receives the local terminal connection information from the third radio device by unicast.

Furthermore, according to the invention, a radio communication system includes a plurality of radio devices each connected with at least one terminal device and include a first radio device, a first terminal device, a second radio device, a second terminal device, and a third radio device. The first and second radio devices do not hold global terminal connection information representing the entire connection between the radio devices and the terminal devices in the radio communication system. The first terminal device is connected with the first radio device. The second terminal device is connected with the second radio device. The third radio device has the global terminal connection information. When the first radio device receives a packet destined to the second terminal device from the first terminal device and does not have first local terminal connection information representing the connection between the second terminal device and the second radio device, the first radio device transmits the packet to the second radio device with the aid of the third radio device. The second radio device receives the packet and transmits the received packet to the second terminal device. The second terminal device receives the packet transmitted from the second radio device.

Preferably, when the first radio device receives the packet from the first terminal device and does not have the first local terminal connection information, the first radio device transmits second local terminal connection information representing the connection between itself and the first terminal device and the packet to the third radio device. The third radio device receives the second local terminal connection information and the packet, determines that the second terminal device to which the received packet is destined is connected with the second radio device based on the global terminal connection information and transmits the second local terminal connection information and the packet to the second radio device. Upon receiving the second local terminal connection information and the packet, the second radio device transmits the packet to the second terminal device. The second terminal device receives the packet transmitted from the second radio device.

Preferably, upon receiving a packet destined to the first terminal device from the second terminal device, the second radio device transmits the first local terminal connection information and the packet to the first radio device. Upon receiving the first local terminal connection information and the packet, the first radio device transmits the received packet to the first terminal device. The first terminal device receives the packet transmitted from the first radio device.

Preferably, when the first radio device receives a packet from the first terminal device and does not have the first local terminal connection information, the first radio device transmits a terminal information request that requests the transmission of the first local terminal connection information to the third radio device by unicast, and upon receiving the first local terminal connection information from the third radio device, the first radio device transmits second local terminal connection information representing the connection between itself and the first terminal device and the packet to the second radio device. Upon receiving the terminal information request, the third radio device extracts the first local terminal connection information based on the global terminal connection information and transmits the extracted information to the first radio device. The second radio device receives the second local terminal connection information and the packet and transmits the received packet to the second terminal device.

Preferably, the first radio device further registers the first local terminal connection information in terminal connection information it holds. The second radio device further registers the second local terminal connection information in terminal connection information it holds.

Preferably, when the first radio device obtains the first local terminal connection information and the second radio device obtains the second local terminal connection information, the first and second radio devices transmit/receive packets between each other without passing through the third radio device.

Furthermore, a radio communication system according to the invention allows a terminal device to carry out radio communication with another terminal device through a radio device and includes a plurality of radio devices. The plurality of radio devices are each connected with at least one terminal device and each have global terminal connection information representing the entire connection between the radio devices and the terminal devices in the radio communication system. When the topology in the radio communication system changes, the plurality of radio devices transmit/receive the change in the topology by minimum necessary communication.

Preferably, when the local terminal connection information held by each of the plurality of radio devices changes, the plurality of radio devices each flood only the change information of the local terminal connection information.

Preferably, the plurality of radio devices include a first radio device and n (n: positive integer) second radio devices. The first radio device updates the connection with the terminal devices. The n second radio devices are present around the first radio device and transmit a connection information request that requests the transmission of updated terminal connection information representing the updated connection to the first radio device in ascending order of distance from the first radio device.

Preferably, the plurality of radio devices include a first radio device and a second radio device. The first radio device has newly joined the radio communication system. The second radio device is adjacent to the first radio device. The first radio device requests the second radio device to transmit the global terminal connection information and receives the global terminal connection information from the second radio device. The second radio device transmits the global terminal connection information it holds to the first radio device in response to the request from the first radio device.

According to the invention, first and second radio devices construct terminal connection information representing the connection between the radio devices and the terminal devices as required and relay radio communication between the first terminal device and the second terminal device. More specifically, the terminal connection information representing the connection between part of the radio devices and the terminal devices is constructed in part of the radio communication system and radio communication is carried out.

Therefore, according to the invention, load required for forming the terminal connection information can be reduced. Consequently, the load in the radio communication system can be reduced.

According to the invention, among the plurality of radio devices forming the radio communication system, only the third radio device connected to the wire cable has the global terminal connection information, and the radio devices other than the third radio device relay radio communication carried out between two terminal devices with the aid of the third radio device.

Therefore, according to the invention, the load required for forming the global terminal connection information can be reduced. Consequently, the load in the radio communication system can be reduced. Since only part of the radio devices hold the global terminal connection information and therefore the load in the radio communication system can be reduced.

Furthermore, according to the invention, when there is change in the topology of the radio communication system, the change in the topology is transmitted to all the radio devices by minimum necessary radio communication.

Therefore, according to the invention, regardless of the presence/absence of topology change, the load in the radio communication system can be reduced as compared to the case in which the information related to the topology is regularly flooded.

### BRIEF DESCRIPTION OF THE SEVERAL VIEWS OF THE DRAWING

FIG. 1 is a schematic diagram of a radio communication system according to a first embodiment of the invention.

FIG. 2 is a schematic block diagram of the configuration of the radio device shown in FIG. 1.

FIG. 3 is a schematic diagram of the configuration of a routing table shown in FIG. 2.

FIG. 4 is a schematic diagram of the structure of global terminal connection information shown in FIG. 2.

FIG. 5 is a schematic diagram of the structure of the neighbor list.

FIGS. 6A to 6D each show a neighbor list produced by each radio device in the radio communication system.

FIG. 7 is a schematic diagram of a conceptual idea of topology information.

FIGS. 8A and 8B are diagrams of examples of local terminal connection information.

FIG. 9 is a diagram of an example of global terminal connection information.

FIGS. 10A and 10B are diagrams for use in illustrating load reducing method 1 in the radio communication system.

FIG. 11 shows the structure of a changed part in local terminal connection information.

FIG. 12 shows another example of the global terminal connection information.

FIG. 13 shows yet another example of the global terminal connection information.

FIG. 14 is a diagram for use in illustrating load reducing method 2.

FIG. 15 is a diagram for use in illustrating load reducing method 3.

FIG. 16 is a schematic diagram of a radio communication system according to a second embodiment.

FIG. 17 is a schematic diagram of the configuration of the radio device shown in FIG. 16.

FIG. 18 is a diagram for use in illustrating load reducing method 4.

FIGS. 19A and 19B are diagrams showing other examples of local terminal connection information.

FIG. 20 is a diagram for use in illustrating load reducing method 5.

FIG. 21 is a schematic diagram of a radio communication system according to a third embodiment of the invention.

FIG. 22 is a schematic diagram for use in illustrating a communication method in a radio communication system shown in FIG. 21.

FIGS. 23A to 23D are diagrams of examples of terminal connection information.

FIG. 24 is a diagram for use in illustrating another communication method in the radio communication system shown in FIG. 21.

FIGS. 25A and 25B are diagrams showing other examples of the terminal connection information.

### DETAILED DESCRIPTION OF THE INVENTION

Embodiments of the invention will be described in detail in conjunction with the accompanying drawings in which the same or corresponding portions are denoted by the same reference characters and their description will not repeated.

### First Embodiment

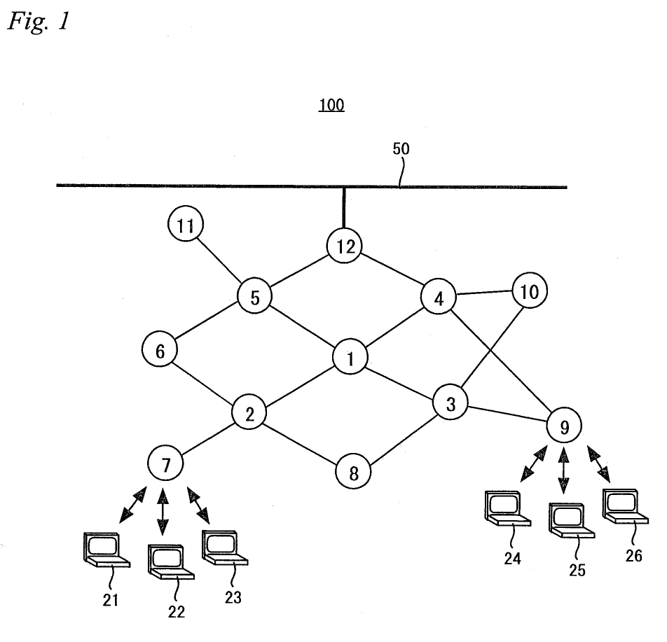

FIG. 1 is a schematic diagram of a radio communication system according to a first embodiment of the invention. With reference to FIG. 1, the radio communication system 100 according to the first embodiment includes radio devices 1 to 12, terminal devices 21 to 26, and a wire cable 50.

Each of the radio devices 1 to 12 is a fixed radio device and made for example of an access point. The radio devices 1 to 12 form a mesh-type radio network. The radio device 12 is a root node, and the radio devices 1 to 11 are radio devices subordinate to the radio device 12. More specifically, the radio devices 1 to 11 have to communicate through the radio device 12 in order to communicate by radio with any radio device existing in another radio communication system. The radio device 12 is connected with the wire cable 50.

The terminal devices 21 to 23 are subordinate to the radio device 7 and connected with the radio device 7. The terminal devices 24 to 26 are subordinate to the radio device 9 and connected with the radio device 9.

Note that FIG. 1 shows the terminal devices 21 to 23 subordinate to the radio device 7 and the terminal devices 24 to 26 subordinate to the radio device 9, while there are also terminal devices subordinate to the radio devices 1 to 6, 8, and 10 to 12.

The radio devices 1 to 12 each produce topology information TPIF representing the arrangement of the radio devices 1 to 12 in the radio communication system 100 and hold the produced topology information TPIF. The radio devices 1 to 12 each produce a routing table used to transmit a packet to each destination based on the topology information TPIF and hold it.

The radio devices 1 to 12 each construct global terminal connection information representing the connection among the radio devices and the terminal devices in the entire radio communication system 100 and hold the information.

In the radio communication system 100, when radio communication is carried out between terminal devices subordinate to difference radio devices, the radio devices 1 to 12 relay a packet between the source terminal device and the destination terminal device using the global terminal connection information.

Now, in the following paragraphs, a mechanism of transmitting and receiving packets between a source terminal device and a destination terminal device with a reduced load in the radio communication system 100 will be described.

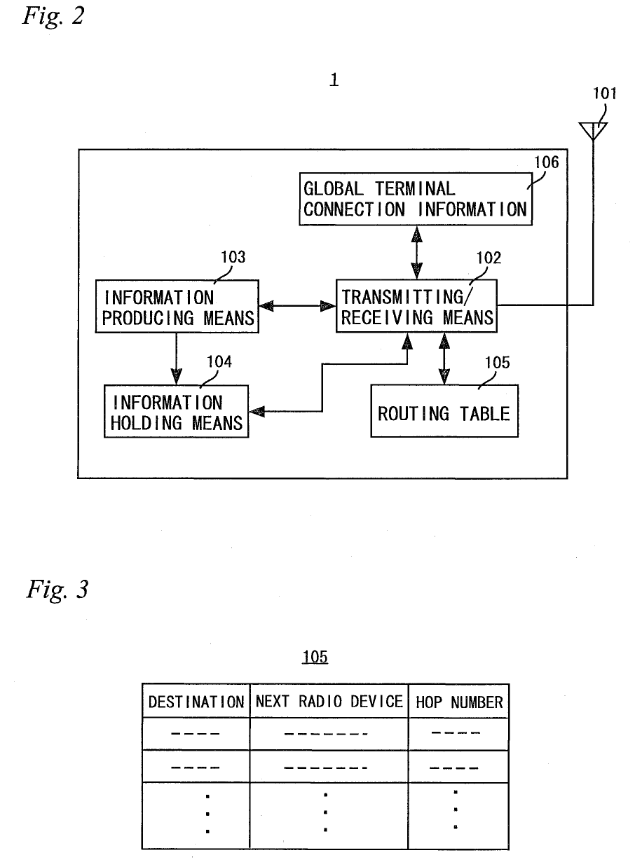

FIG. 2 is a schematic block diagram of the configuration of the radio device 1 shown in FIG. 1. With reference to FIG. 2, the radio device 1 includes an antenna 101, transmitting/receiving means 102, information producing means 103, information holding means 104, a routing table 105, and global terminal connection information 106.

The antenna 101 transmits a packet received from the transmitting/receiving means 102 to another radio device and outputs a packet received from another radio device to the transmitting/receiving means 102.

The transmitting/receiving means 102 outputs a control packet PKT_CL and a neighbor list NTBL received through the antenna 101 to the information producing means 103. The transmitting/receiving means 102 also reads a neighbor list NTBL or topology information TPIF from the information holding means 104 and transmits the read neighbor list NTBL or topology information TPIF to another radio device through the antenna 101. The transmitting/receiving means 102 also calculates an optimum route to transmit a packet to each destination based on the topology information TPIF read from the information holding means 104 and produces a routing table 105. The transmitting/receiving means 102 produces local terminal connection information representing the connection between the radio device 1 and the terminal devices subordinate to the radio device 1 based on the access states to the radio device 1 by the terminal devices subordinate to the radio device 1.

The transmitting/receiving means 102 receives local terminal connection information produced in another radio device through the antenna 101 from the radio device. In this way, the transmitting/receiving means 102 produces global terminal connection information 106 representing the connection among the radio devices and the terminal devices in the entire radio communication system 100 based on the local terminal connection information produced by itself and the local connection information received from the other radio devices. When the terminal devices subordinate to the radio device 1 change (increase and/or decrease), the transmitting/receiving means 102 updates the local terminal connection information and floods the changed part in the local terminal connection information through the antenna 101. If the checksum of the local terminal connection information received from other radio devices and the already received checksum disagree, the transmitting/receiving means 102 calculates the number of hops from the radio device 1 to the radio device as the source of the local terminal connection information based on the topology information TPIF and transmits a transmission request for the local terminal connection information to the source radio device at a transmission interval determined according to the calculated hop number. In this case, the transmitting/receiving means 102 transmits a transmission request for the local terminal connection information at a relatively small interval to the source radio device if the calculated hop number is relatively small and at a relatively long interval if the calculated hop number is relatively large.

The transmitting/receiving means 102 transmits a transmission request for global terminal connection information to a radio device adjacent to the radio device 1 if the radio device 1 has newly joined the radio communication system 100. Upon receiving a transmission request for global terminal connection information from a radio device adjacent to the radio device 1, the transmitting/receiving means 102 transmits the global terminal connection information 106 to the adjacent device. Furthermore, upon receiving a packet destined to a terminal device subordinate to another radio device from a terminal device subordinate to the radio device 1 through the antenna 101, the transmitting/receiving means 102 refers to the global terminal connection information 106 to detect the radio device to which the source terminal device belongs and transmits the packet received from the subordinate terminal device to the detected radio device. Upon receiving a packet destined to a terminal device subordinate to the radio device 1 trough the antenna 1, the transmitting/receiving means 102 transmits the received packet to the terminal device subordinate to the radio device 1.

Upon receiving a control packet PKT_CL that the transmitting/receiving means 102 has received from another radio device, the information producing means 103 produces a neighbor list NTBL for radio devices adjacent to the radio device 1 based on the received control packet PKT_CL and stores the produced neighbor list NTBL in the information holding means 104. Upon receiving a neighbor list NTBL that the transmitting/receiving means 102 has received from another radio device, the information producing means 103 produces topology information TPIF based on the received neighbor list NTBL according to a method that will be described and stores the produced topology information TPIF in the information holding means 104.

The information holding means 104 stores the neighbor list NTBL and the topology information TPIF produced by the information producing means 103.

FIG. 3 is a schematic diagram of the configuration of the routing table 105 shown in FIG. 2. With reference to FIG. 3, the routing table 105 includes information about a destination, the next radio device, and the hop number. The destination, the next radio device and the hop number are associated with one another. The “destination” represents the MAC address of the destination radio device. The “next radio device” represents the MAC address of a radio device to be the next destination when a packet PKT is transmitted to the destination. The “hop number” is the number of hops required to the destination. For example, in FIG. 1, if radio communication is carried out between the radio device 1 and the radio device 9 along the route from the radio device 1 via the radio device 3 to the radio device 9, “2” is stored as the hop number for the radio device 1 in the routing table 105.

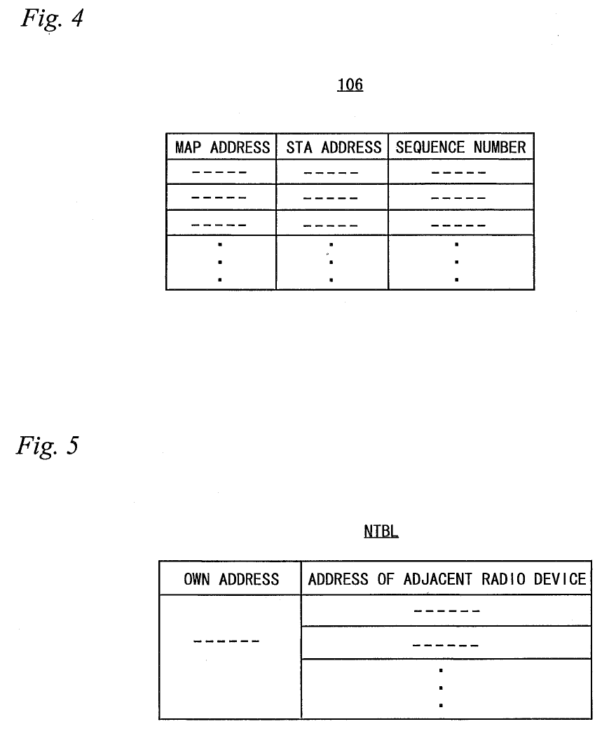

FIG. 4 is a schematic diagram of the configuration of the global terminal connection information 106 shown in FIG. 2. With reference to FIG. 4, the global terminal connection information 106 includes an MAP address, an STA address, and a sequence number. The MAP address, the STA address, and the sequence number are associated with one another.

The MAP address includes the MAC addresses of the radio devices 1 to 12. The STA address includes the MAC addresses of the terminal devices subordinated to each radio device. The sequence number is an integer and larger values represent newer terminal connection information.

Note that the local terminal connection information produced in each of the radio devices 1 to 12 includes an “MAP address,” an “STA address,” and a “sequence number” shown in FIG. 4.

FIG. 5 is a schematic diagram of the neighbor list NTBL. With reference to FIG. 5, the neighbor list NTBL includes its own address and the addresses of neighboring radio devices. Its “own address” consists of the MAC address of a radio device for which a neighbor list NTBL is to be produced. The “addresses of adjacent radio devices” consist of the MAC addresses of the radio devices adjacent to the radio device for which the neighbor list NTBL is to be produced.

According to the invention, the radio devices 1 to 12 each produce a routing table 105 according to the OLSR protocol. How the routing table 105 is produced according to the OLSR protocol will be described in detail. The radio devices 1 to 12 each transmit/receive a Hello message and a TC message in order to produce a routing table 105.

The Hello message is periodically transmitted for the purpose of distributing information possessed by each of the radio devices 1 to 12. The radio devices 1 to 12 can each collect information related to peripheral radio devices by receiving the Hello messages and can be aware of what radio devices are located around them.

In the OLSR protocol, the radio devices 1 to 12 manage local link information. The Hello message is used to form and transmit the local link information. The local link information includes a “link set,” an “adjacent radio device set,” a “2-hop adjacent radio device set and a link set to the radio devices,” an “MPR set,” and an “MPR selector set.”

The link set refers to a link to a set of radio devices (adjacent radio devices) which a radio wave directly reach, and each link is represented by effective time for an address set between two radio devices. Note that the effective time can also be used to express if the link is a one-way or two-way link.

The adjacent radio device set includes the addresses of adjacent radio devices and the retransmission willingness of the radio devices. The two hop adjacent radio device set represents a set of radio devices adjacent to the adjacent radio devices.

An MPR set is a set of radio devices selected as MPR. Note that the MPR means selection of a relay device in transmitting each packet PKT to all the radio devices 1 to 12 in the radio communication system 100 so that the packet PKT can be transmitted to all the radio devices 1 to 12 by a minimum necessary number times of communication. The MPR selector set is a set of radio devices that have selected themselves as MPR.

The local link information is generally established as follows. The radio devices 1 to 12 each transmit a Hello message including each own address to adjacent radio devices to inform about their presence in an early stage. This is carried out by all the radio devices 1 to 12, and the radio devices 1 to 12 are each aware of what addresses the surrounding radio devices have. In this way, the link set and the adjacent radio device set are formed.

The produced local link information again continues to be transmitted periodically by Hello message. The repetition gradually makes it clear whether each link is two-way or what radio device is present ahead of adjacent radio devices. The radio devices 1 to 12 each store the thus gradually formed local link information.

Furthermore, information related to MPR is also periodically transmitted by Hello message and given to each of the radio devices 1 to 12. The radio devices 1 to 12 each select several radio devices as an MPR set among adjacent radio devices so that the radio devices can request them to retransmit a packet PKT which each of the radio devices transmits. Information related to the MPR set is transmitted to adjacent radio devices by Hello message, and therefore a radio device that receives the Hello message manages the set of radio devices that have selected the radio device as MPR as an “MPR selector set.” In this way, each of the radio devices 1 to 12 can instantaneously recognize that a packet PKT received from which radio device should be retransmitted.

When a local link set is established in each of the radio devices 1 to 12 in response to the transmission and reception of Hello messages, a TC message to inform the topology of the entire radio communication system 100 is transmitted to the radio devices 1 to 12. The TC message is periodically transmitted by all the radio devices selected as MPR. The TC message includes a link between each radio device and the MPR selector set, and therefore all the radio devices 1 to 12 in the radio communication system 100 are informed of all the MPR sets and all the MPR selector sets and of the topology of the entire radio communication system 100 or part thereof based on all the MPR sets and all the MPR selector sets. The radio devices 1 to 12 each calculate the shortest route using the topology of the entire radio communication system 100 and produces a routing table based thereon.

Note that the radio devices 1 to 12 each exchange TC messages frequently aside from the Hello message. The MPR is also used for such exchange of TC messages. The radio devices 1 to 12 each transmit/receive the above described Hello message and TC message, recognize the topology of the entire radio communication system 100, calculate the shortest route based on the topology of the entire radio communication system 100, and dynamically produce the routing table 105 shown in FIG. 3 based on the result.

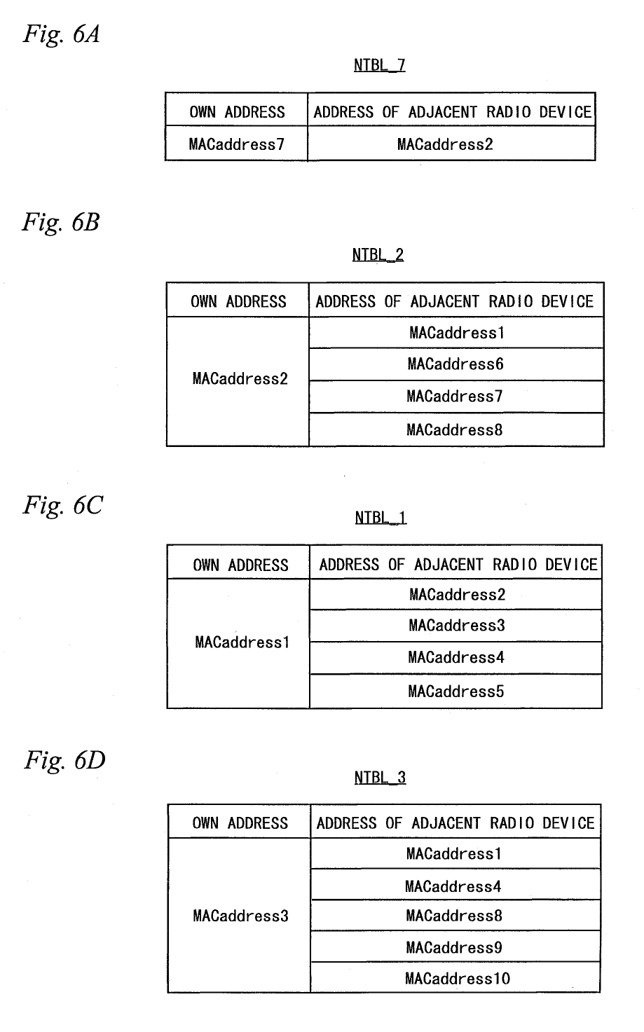

FIGS. 6A to 6D each show a neighbor list produced by each radio device in the radio communication system 100. With reference to FIG. 6A, the transmitting/receiving means 102 of the radio device 7 directly receives a Hello message=[MACaddress2] from the radio device 2 and outputs the received Hello message=[MACaddress2] to the information producing means 103.

The information producing means 103 of the radio device 7 receives the Hello message=[MACaddress2] from the transmitting/receiving means 102 and produces a neighbor list NTBL_7 in the radio device 7 based on the received Hello message=[MACaddress2] (see FIG. 6A). The information producing means 103 of the radio device 7 stores the produced neighbor list NTBL_7 in the information holding means 104.

The transmitting/receiving means 102 of the radio device 7 reads out the neighbor list NTBL_7 from the information holding means 104 once the neighbor list NTBL_7 is stored in the information holding means 104 and produces a Hello message including the read out neighbor list NTBL_7 and transmits the message. The transmitting/receiving means 102 of the radio device 7 produces a TC message including the IP address of the radio device that is MPR for the radio device 7 and floods it in the radio communication system 100.

The transmitting/receiving means 102 of the radio device 2 produces a neighbor list NTBL_2 (see FIG. 6B) by the above-described operation, produces a Hello message including the produced neighbor list NTBL_2 and transmits it. In this way, the transmitting/receiving means 102 in the radio devices 1 and 6 to 8 can be aware of what radio devices exist in the region two hops from the radio devices 1 and 6 to 8. The transmitting/receiving means 102 of the radio device 2 produces a TC message including the IP address of the radio device that is MPR for the radio device 2 and floods it in the radio communication system 100.

Furthermore, the radio devices 1 and 3 produce neighbor lists NTBL_1 and NTBL_3, respectively (see FIGS. 6C and 6D), produce Hello messages including the neighbor lists NTBL_1 and NTBL_3 and transmit them. In this way, the transmitting/receiving means 102 of each of the radio devices 2 to 5 that have received the Hello message including the neighbor list NTBL_1 can be aware of what radio devices exist in the region two hops from the radio devices 2 to 5. The transmitting/receiving means 102 of the radio devices 1, 4, and 8 to 10 that have received the Hello message including the neighbor list NTBL_3 can be aware of what radio devices exist in the region two hops from the radio devices 1, 4, and 8 to 10. The transmitting/receiving means 102 in the radio devices 1 and 3 each produce a TC message including the IP address of a radio device that is MPR for each of the radio devices 1 and 3 and floods each message in the radio communication system 100.

The other radio devices 4, 5, 6, and 8 to 12 produce their neighbor lists by the above-described operation, transmit Hello messages including the produced neighbor lists, produces TC messages including the IP addresses of radio devices that are MPR for them and flood them in the radio communication system 100.

By the above-described operation, the radio device 7 is aware of the radio devices 1, 2, 6, and 8 present in its two hop region and of radio devices as MPR for the radio devices 1 to 6 and 8 to 12.

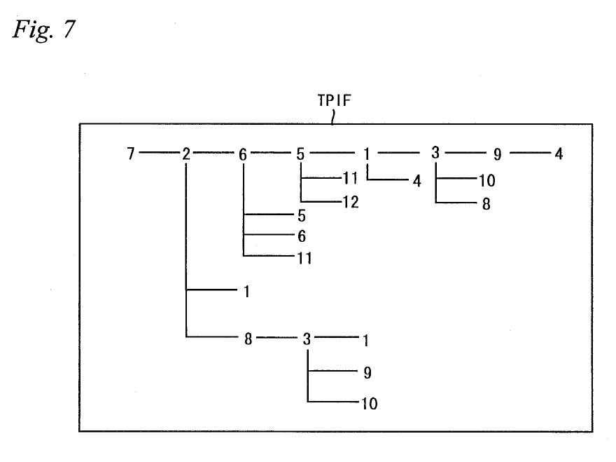

FIG. 7 is a schematic diagram showing a conceptual idea of topology information. Note that the topology information TPIF shown in FIG. 7 does not represent the complete topology of the radio devices 1 to 12 forming the radio communication system 100 and part of the topology is not shown.

With reference to FIG. 7, in the radio device 7, the transmitting/receiving means 102 is aware of the radio devices 1, 2, 6, and 8 present in its two-hop region and of radio devices that are MPR for the radio devices 1 to 6 and 8 to 12, so that topology information TPIF representing the topology of the radio devices 1 to 12 forming the radio communication system 100 is produced.

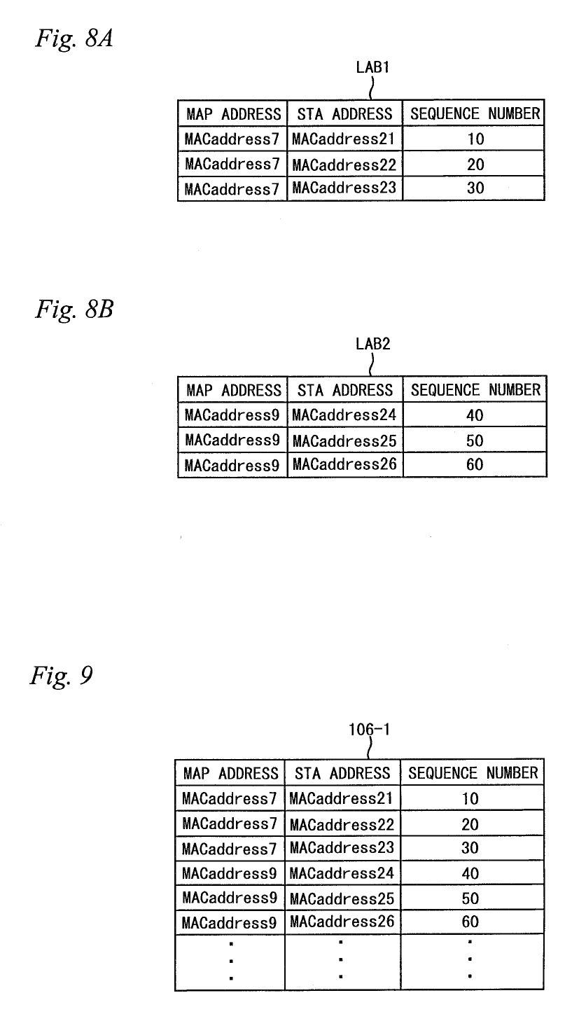

FIGS. 8A and 8B are diagrams showing examples of local terminal connection information. FIG. 9 is a diagram of an example of global terminal connection information. The transmitting/receiving means 102 of the radio device 7 shown in FIG. 1 detects terminal devices 21 to 23 as the terminal devices present subordinate to the radio device 7 based on the MAC addresses of packets received from the terminal devices 21 to 23, produces local terminal connection information LAB1 (see FIG. 8A), and floods the produced local terminal connection information LAB1 in the radio communication system 100.

The transmitting/receiving means 102 of the radio device 9 similarly produces local terminal connection information LAB2 (see FIG. 8B) and floods the local terminal connection information LAB2 in the radio communication system 100.

In this case, the transmitting/receiving means 102 of the radio device 7 stores the local terminal connection information LAB1 in a single packet to flood if the information can be stored in a single packet and otherwise it divides the local terminal connection information LAB1 into two or more blocks and stores the two or more blocks in two or more packets to flood if the information cannot be stored in a single packet. The transmitting/receiving means 102 of the radio device 9 similarly floods local terminal connection information LAB2.

Note that the transmitting/receiving means 102 of each of the radio devices 1 to 6, 8, and 10 to 12 similarly produces local terminal connection information and floods the produced local terminal connection information in the radio communication system 100.

In this way, the transmitting/receiving means 102 of the radio device 7 receives the local terminal connection information LAB2, . . . from the radio devices 1 to 6 and 8 to 12 other than the radio device 7, produces global terminal connection information 106-1 (see FIG. 9) representing the connection between the radio devices and the terminal devices in the entire radio communication system 100 based on the received local terminal connection information LAB2, . . . and the local terminal connection information LAB1 it has produced, and holds the produced global terminal connection information 106-1.

Similarly, the radio devices 1 to 6 and 8 to 12 each produce the global terminal connection information 106-1 and hold the produced global terminal connection information 106-1.

As described above, according to the first embodiment, all the radio devices 1 to 12 present in the radio communication system 100 produce the global terminal connection information 106-1 and hold the information. In this way, upon receiving a packet destined to the terminal device 24 from the terminal device 21, for example, the transmitting/receiving means 102 of the radio device 7 can instantaneously determine that the packet received from the terminal device 21 needs only be transmitted to the radio device 9 in order to transmit the packet to the terminal device 24 by referring to the global terminal connection information 106-1.

The operation of how packets are transmitted/received between the terminal device 21 and the terminal device 24 will be described in detail. The terminal device 21 produces a packet destined to the terminal device 24 and transmits the produced packet to the radio device 7.

The transmitting/receiving means 102 of the radio device 7 receives the packet from the terminal device 21 through the antenna 101 and refers to the header of the received packet to detect the terminal device 24 as the destination of the packet.

The transmitting/receiving means 102 of the radio device 7 then refers to the global terminal connection information 106-1 and determines that the terminal device 24 is connected to the radio device 9. The transmitting/receiving means 102 of the radio device 7 refers to the routing table 105 to determine the route from the radio device 7 via the radio device 2, the radio device 8, and the radio device 3 to the radio device 9 as the route along which the packet is to be transmitted to the radio device 9 and transmits the packet along the determined route.

The transmitting/receiving means 102 of the radio devices 2, 8, and 3 relays the packet received from the radio devices 7, 2, and 8, respectively to the radio devices 8, 3, and 9. In this case, the transmitting/receiving means 102 of each of the radio devices 2, 8, and 3 determines that the terminal device 24 to which the received packet is destined is different from any of their subordinate terminal devices by referring to the global terminal connection information 106-1. The transmitting/receiving means 102 of the radio devices 2, 8, and 3, therefore, relay the received packet to the radio devices 8, 3, and 9, respectively.

The transmitting/receiving means 102 of the radio device 9 receives the packet transmitted from the radio device 7 and determines that the received packet is destined to the terminal device 24 by referring to the header of the received packet. Then, the transmitting/receiving means 102 of the radio device 9 determines that the terminal device 24 to which the received packet is destined is one of terminal devices subordinate to the radio device 9 by referring to the global terminal connection information 106-1, and transmits the packet received from the radio device 3 to the terminal device 24. The terminal device 24 receives the packet from the radio device 9. In this way, the packet is transmitted from the terminal device 21 as the source to the terminal device 24 as the destination.

Upon receiving the packet, the terminal device 24 produces a packet destined to the terminal device 21 and transmits it to the radio device 9. The transmitting/receiving means 102 of the radio device 9 receives the packet from the terminal device 24 and determines that the destination of the packet is the terminal device 21 by referring to the header of the received packet.

The transmitting/receiving means 102 of the radio device 9 determines that the terminal device 21 is connected to the radio device 7 by referring to the global terminal connection information 106-1. The transmitting/receiving means 102 of the radio device 9 then refers to the routing table 105 to determine the route from the radio device 9 via the radio device 3, the radio device 8, and the radio device 2 to the radio device 7 as the route along which the packet is to be transmitted to the radio device 7 and transmits the packet along the determined route to the radio device 7.

The transmitting/receiving means 102 of the radio devices 3, 8, 2 relays the packet received from the radio devices 9, 3, and 8 to the radio devices 8, 2, and 7, respectively. In this case, the transmitting/receiving means 102 of each of the radio devices 3, 8, and 2 determines that the terminal device 21 to which the received packet is destined is different from any of their subordinate terminal devices by referring to the global terminal connection information 106-1. The transmitting/receiving means 102 of the radio devices 3, 8, and 2, therefore, relay the received packet to the radio devices 8, 2, and 7, respectively.

The transmitting/receiving means 102 of the radio device 7 receives the packet transmitted from the radio device 9 and determines that the received packet is destined to the terminal device 21 by referring to the header of the received packet. Then, the transmitting/receiving means 102 of the radio device 7 refers to the global terminal connection information 106-1 to determine that the terminal device 21 to which the packet is destined is one of terminal devices subordinate to the radio device 7 and transmits the packet received from the radio device 2 to the terminal device 21. The terminal device 21 receives the packet from the radio device 7. In this way, the packet is transmitted from the terminal device 24 as the source to the terminal device 21 as the destination.

As described above, using the global terminal connection information 106-1 held by the radio devices 1 to 12, radio communication is carried out between the terminal device 21 and the terminal device 24.

A load reducing method in the radio communication system 100 in which radio communication is carried out by the above-described method will be described.

Reducing Method 1

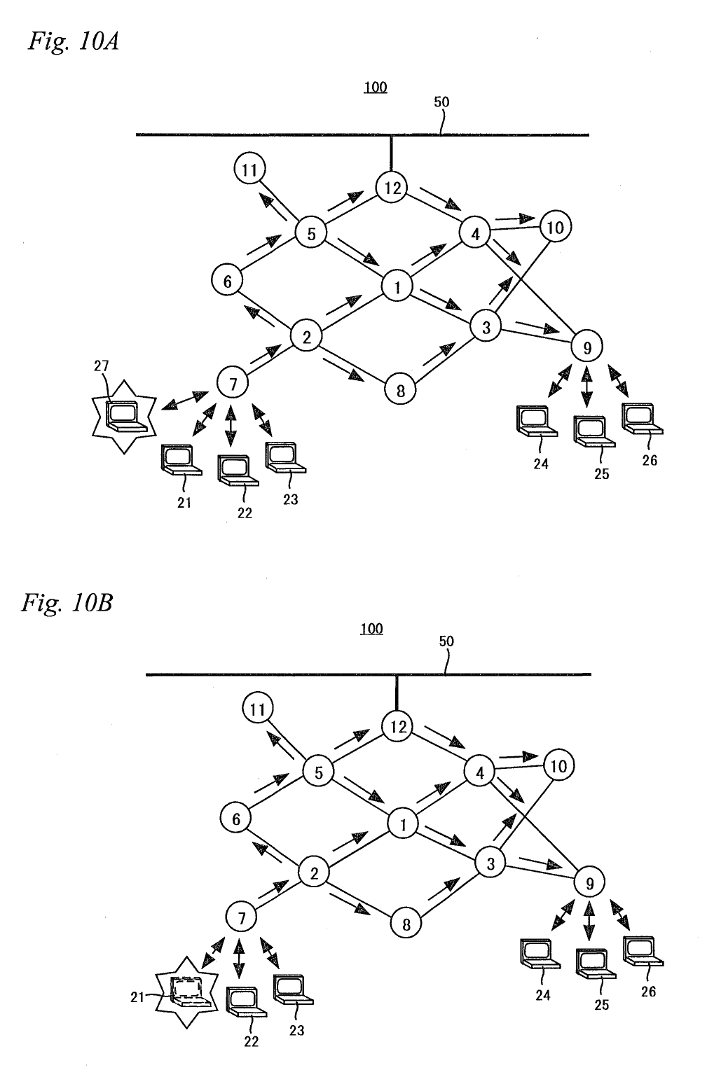

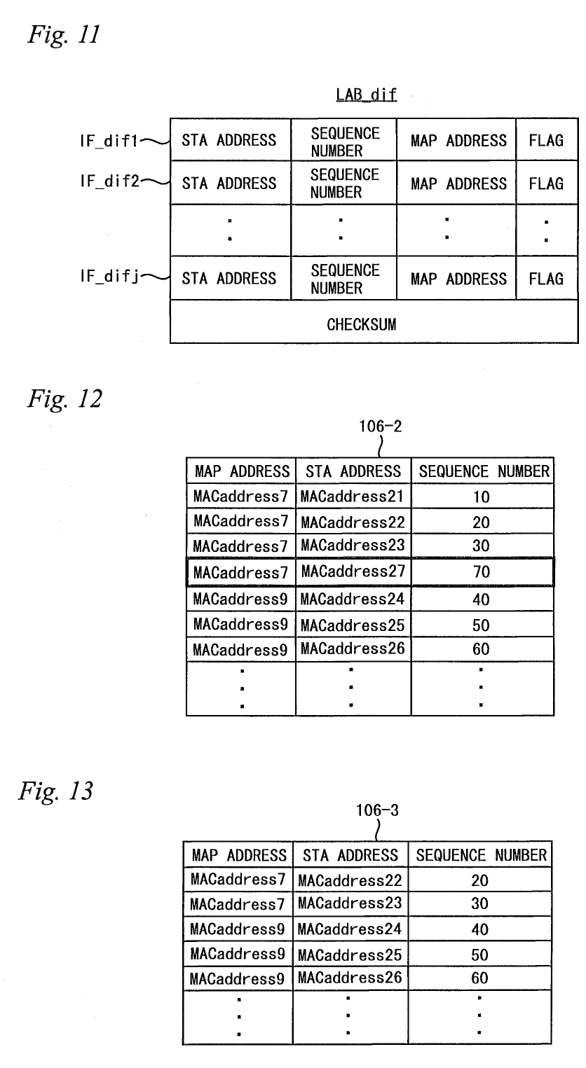

FIGS. 10A and 10B are diagrams for use in illustrating load reducing method 1 in the radio communication system 100. FIG. 11 is a diagram showing the structure of a changed part in local terminal connection information. FIGS. 12 and 13 are diagrams of other examples of global terminal connection information.

According to the first embodiment, provided that the radio devices 1 to 12 forming the radio communication system 100 each hold the global terminal connection information 106, if each of their own local terminal connection information LAB changes, the radio devices 1 to 12 each flood only the changed part in the radio communication system 100.

The local terminal connection information LAB changes for example when the number of terminal devices subordinate to each of the radio devices 1 to 12 increases or decreases. A radio device whose local terminal connection information LAB has changed produces a changed part LAB_dif in the local terminal connection information LAB (see FIG. 11) and floods the part in the radio communication system 100. In this case, the changed part LAB_dif consists of change information IF_dif1 to IF_difj (j: positive integer) and a checksum CSM.

Each of the change information IF_dif1 to IF_difj includes an STA address, a sequence number, an MAP address, and a flag. The STA address is the MAC address of the terminal device that has gone through the change. More specifically, the STA address is the MAC address of the added or deleted terminal device.

The sequence number is a sequence number corresponding to the MAC address of the terminal device that has gone through the change in the local terminal connection information LAB. The MAP address is the MAC address of the radio device to which the terminal device that has gone through the change has belonged or belongs.

The flag represents whether the change information IF_dif1 to IF_difj are additional pieces of information or deleted pieces of information. The flag is “1” if IF_dif1 to IF_difj are additional pieces of information and “0” if IF_dif1 to IF_difj are produced pieces of information.

The checksum CSM is the checksum of updated local terminal connection information LAB.

With reference to FIG. 10A, if the terminal devices subordinate to the radio device 7 increases from the terminal devices 21 to 23 to terminal devices 21 to 23 and 27, the transmitting/receiving means 102 of the radio device 7 detects the increase of the terminal devices subordinate to the radio device 7 from the terminal devices 21 to 23 to terminal devices 21 to 23 and 27 and produces the changed part LAB_dif=[MACaddress27/70/MACaddress7/1/CMS1] of the local terminal connection information LAB and floods the produced changed part LAB_dif=[MACaddress27/70/MACaddress7/1/CMS1] in the radio communication system 100. (The arrow in FIG. 10A expresses the flooding).

Then, the radio devices 1 to 6 and 8 to 12 in the radio communication system 100 each receive the changed part LAB_dif=[MACaddress27/70/MACaddress7/1/CMS1] transmitted from the radio device 7. Then, the transmitting/receiving means 102 of each of the radio devices 1 to 6 and 8 to 12 detects “MACaddress27”, “Macaddress7” and “1” in the changed part LAB_dif=[MACaddress27/70/MACaddress7/1/CMS1] and the addition of the terminal device 27 as a terminal device belonging to the radio device 7. Upon detecting the addition of the terminal device 27 as a terminal device belonging to the radio device 7, the radio devices 1 to 6 and 8 to 12 add the terminal device 27 as a terminal device belonging to the radio device 7 in the global terminal connection information 106-1 and thus update the global terminal connection information 106-1 to global terminal connection information 106-2 (see FIG. 12).

With reference to FIG. 10B, when the number of terminal devices subordinate to the radio device 7 is reduced from the terminal devices 21 to 23 to the terminal devices 22 and 23, the transmitting/receiving means 102 of the radio device 7 detects the decrease of the terminal devices belonging to the radio device 7 from the terminal devices 21 to 23 to the terminal devices 22 and 23, produces the changed part LAB_dif=[MACaddress21/10/MACaddress7/0/CSM2] in the local terminal connection information LAB and floods the produced changed part LAB_dif=[MACaddress21/10/MACaddress7/0/CSM2] in the radio communication system 100. (The arrow in FIG. 10B represents the flooding).

Then, the radio devices 1 to 6 and 8 to 12 in the radio communication system 100 each receive the changed part LAB_dif=[MACaddress21/10/MACaddress7/0/CSM2] transmitted from the radio device 7. The transmitting/receiving means 102 of the radio devices 1 to 6 and 8 to 12 each detect “MACaddress21”, “MACaddress7” and “0” in the received changed part LAB_dif=[MACaddress21/10/MACaddress7/0/CSM2] and detects the deletion of the terminal device 21 from the terminal devices belonging to the radio device 7. Upon detecting the deletion of the terminal device 21 from the terminal devices belonging to the radio device 7, the radio devices 1 to 6 and 8 to 12 each delete the terminal device 21 from the global terminal connection information 106-1 and update the global terminal connection information 106-1 to global terminal connection information 106-3 (see FIG. 13).

Note that similarly to the radio device 7, the radio devices 1 to 6 and 8 to 12 each produce a changed part LAB_dif in their own local terminal connection information LAB and flood it in the radio communication system 100, while upon receiving the change part LAB_dif from any of the radio devices 1 to 6 and 8 to 12, a radio device updates its own global terminal connection information 106 by the above-described method.

The checksum CSM after updating the local terminal connection information LAB is included in the changed part LAB_dif for the following reason. When the terminal devices 27 and 28 are added as terminal devices belonging to the radio device 7, the radio device 7 floods the changed part LAB_dif=[MACaddress27/70/MACaddress7/1/MACaddress28/71/MACaddress7/1/CSM3] and the radio devices 1 to 6 and 8 to 12 each receive the changed part LAB_dif=[MACaddress27/70/MACaddress7/1/MACaddress28/71/MACaddress7/1/CSM3]. In this case, assume that the radio devices 1 to 6 and 8 to 12 each accurately receive “MACaddress27/70/MACaddress7” in the changed part LAB_dif=[MACaddress27/70/MACaddress7/1/MACaddress28/71/MACaddress7/1/CSM3] and cannot accurately receive “MACaddress28/71/MACaddress7”.

Then, the radio devices 1 to 6 and 8 to 12 add the “MACaddress27/70/MACaddress7” to their own local terminal connection information LAB and update the local terminal connection information LAB. The radio devices 1 to 6 and 8 to 12 each calculate the checksum CSMx of the updated local terminal connection information LAB, determine whether the checksum CSMx and the checksum CSM3 included in LAB_dif=[MACaddress27/70/MACaddress7/1/MACaddress28/71/MACaddress7/1/CSM3] match and detect the inconsistency between the checksum CSMx and the checksum CSM3.

As a result, the radio devices 1 to 6 and 8 to 12 each detect the incorrect reception of the changed part LAB_dif=[MACaddress27/70/MACaddress7/1/MACaddress28/71/MACaddress7/1/CSM3] and transmits a transmission request ABBR to request the source radio device 7 to transmit updated local terminal connection information LAB.

On the other hand, if the changed part LAB_dif=[MACaddress27/70/MACaddress7/1/MACaddress28/71/MACaddress7/1/CSM3] is accurately received, the checksum CSMx matches the checksum CSM3, and therefore the radio devices 1 to 6 and 8 to 12 each confirm the coincidence between the checksum CSMx and the checksum CSM3 to determine that the changed part LAB_dif=[MACaddress27/70/MACaddress7/1/MACaddress28/71/MACaddress7/1/CSM3] has accurately been received.

In this way, in order to determine whether a changed part LAB_dif has accurately been received, the checksum CSM of the updated local terminal connection information LAB is included in the changed part LAB_dif.

In this way, according to load reducing method 1, only when each own local terminal connection information LAB changes, each of the radio devices 1 to 12 produces the changed part LAB_dif and floods it in the radio communication system 100. Therefore, as compared to the conventional method according to which local terminal connection information LAB is periodically flooded in the radio communication system 100 according to FDM (Full Base Diffusion Mode), the load in the radio communication system 100 can be reduced.

Reducing Method 2

According to load reducing method 2, when local terminal connection information LAB in each of radio devices 1 to 12 changes, each of the radio devices 1 to 12 calculates the checksum of the local terminal connection information LAB according to CDM (Checksum Diffusion Mode) and floods the calculated checksum in the radio communication system 100.

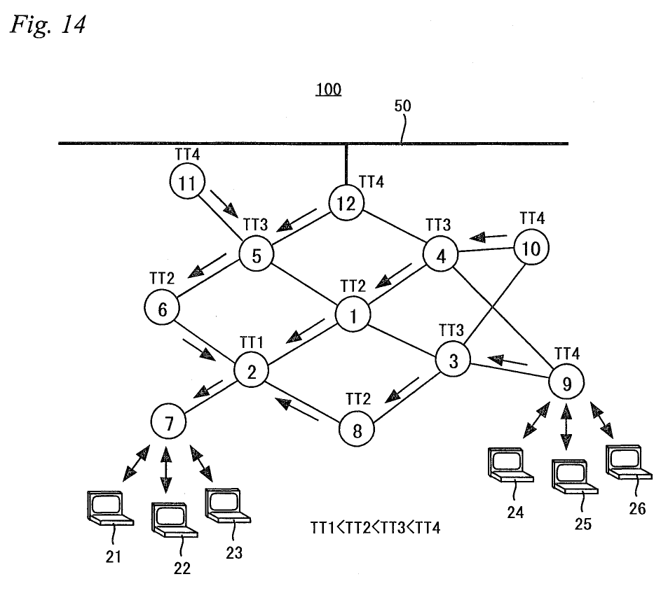

FIG. 14 is a diagram for use in illustrating load reducing method 2. With reference to FIG. 14, when local terminal connection information in the radio device 7 is updated, the transmitting/receiving means 102 of the radio device 7 for example calculates the checksum CSM of the updated local terminal connection information LAB and floods the calculated checksum CSM in the radio communication system 100.

The transmitting/receiving means 102 in each of the radio devices 1 to 6 and 8 to 12 receives the checksum CSM transmitted from the radio device 7, compares the received checksum CSM with the already received checksum CSM and detects the hop number from the radio devices 1 to 6 and 8 to 12 to the radio device 7 as the source of the checksum CSM based on the topology information TPIF if the checksums do not match.

The transmitting/receiving means 102 of the radio device 2 for example detects “1” as the hop number from the radio device 2 to the radio device 7 and the transmitting/receiving means 102 of each of the radio devices 1, 6, and 8 detects “2” as the hop number from the radio devices 1, 6, and 8 to the radio device 7. The transmitting/receiving means 102 of each of the radio devices 3 to 5 detects “3” as the hop number from the radio devices 3 to 5 to the radio device 7, and the transmitting/receiving means 102 of each of the radio devices 9 to 12 detects “4” as the hop number from the radio devices 9 to 12 to the radio device 7.

Then, the transmitting/receiving means 102 of each of the radio devices 1 to 6 and 8 to 12 determines a transmission interval at which a transmission request for local terminal connection information LAB (ABBR: Association Base Block Request) is transmitted according to the detected hop number. The hop number from the radio device 2 to the radio device 7 is “1” and the smallest, and therefore the transmitting/receiving means 102 of the radio device 2 determines the shortest transmission interval TT1. The hop number from the radio devices 1, 6, and 8 to the radio device 7 is “2” and the second smallest, and therefore the transmitting/receiving means 102 of each of the radio devices 1, 6, and 8 determines the second shortest transmission interval TT2. The hop number from the radio devices 3 to 5 to the radio device 7 is “3” and the third smallest, and therefore, transmitting/receiving means 102 of each of the radio devices 3 to 5 determines the third shortest transmission interval TT3. The hop number from the radio devices 9 to 12 to the radio device 7 is “4” and the largest, and therefore the transmitting/receiving means 102 of each of the radio devices 9 to 12 determines the longest transmission interval TT4.

In this case, the radio devices 1 to 12 each hold an association table between the hop number to the source of a checksum CSM and the transmission interval for a transmission request ABBR, and therefore when the hop number to the source of the checksum CSM is detected, the transmission interval for the transmission request ABBR is determined with reference to the association table.

The transmitting/receiving means 102 of the radio device 2 transmits a transmission request ABBR for local terminal connection information LAB to the radio device 7 at the transmission interval TT1, the transmitting/receiving means 102 of each of the radio devices 1, 6, and 8 transmits a transmission request ABBR for local terminal connection information LAB to the radio device 7 at the transmission interval TT2, the transmitting/receiving means 102 of each of the radio devices 3 to 5 transmits a transmission request ABBR for local terminal connection information LAB to the radio device 7 at the transmission interval TT3, and the transmitting/receiving means 102 of each of the radio devices 9 to 12 transmits a transmission request ABBR for local terminal connection information LAB to the radio device 7 at the transmission interval TT4. As a result, the transmission request ABBR by the radio device 2 is the earliest in transmission timing, and the transmission request ABBR by the radio devices 1, 6, and 8 is the second earliest in transmission timing, the transmission request ABBR by the radio devices 3 to 5 is the third earliest in transmission timing, and the transmission request ABBR by the radio devices 9 to 12 is the latest in transmission timing. More specifically, the transmitting/receiving means 102 of the radio devices 1 to 6 and 8 to 12 transmits a transmission request ABBR for local terminal connection information LAB to the radio device 7 sequentially in ascending order of distance from the radio device 7 as the source of the checksum CSM.

The transmitting/receiving means 102 of the radio device 7 as the source of the checksum CSM sequentially receives the transmission requests ABBR for the local terminal connection information LAB from the radio devices 1 to 6 and 8 to 12 and floods the updated local terminal connection information LAB in the radio communication system 100.

The transmitting/receiving means 102 of each of the radio devices 1 to 6 and 8 to 12 receives the updated local terminal connection information LAB from the radio device 7 and updates their own global terminal connection information 106 based on the received local terminal connection information LAB.

In this way, according to load reducing method 2, upon receiving a checksum CSM different from an already received checksum, the transmitting/receiving means 102 of each of the radio devices 1 to 6 and 8 to 12 transmits a transmission request ABBR for local terminal connection information LAB to the radio device 7 sequentially in ascending order of distance from the radio device 7 as the source of the checksum CSM, and therefore the transmission requests ABBR can be prevented from concentrating at the radio device 7. Consequently, as compared to the case in which the radio devices 1 to 6 and 8 to 12 transmit the transmission requests ABBR in the same timing, the load in the radio communication system 100 can be reduced.

Upon receiving a transmission request ABBR from the radio device 2, the radio device 7 floods updated local terminal connection information LAB and therefore the radio devices 9 to 11 present in the furthermost positions from the radio device 7 can sometimes receive the updated local terminal connection information LAB from the radio device 7 before transmitting the transmission request ABBR to the radio device 7. In this case, the transmission request ABBR does not have to be transmitted to the radio device 7 after all. Consequently, the load in the radio communication system 100 can be reduced as compared to the case in which the radio devices 1 to 6 and 8 to 12 transmit the transmission requests ABBR in the same timing.

Note that in the above description, the radio devices 1, 6, and 8 whose hop number to the radio device 7 as the source of the checksum is the same transmit a transmission request ABBR at the same transmission interval TT2, while according to the invention, among the radio devices 1, 6, and 8, a radio device that is MPR for the radio device 7 may transmit a transmission request ABBR at a shorter interval (i.e., in earlier timing) than that of a radio device that is not MPR for the radio device 7. The same also applies to the radio devices 3 to 5 and the radio devices 9 to 12.

Reducing Method 3

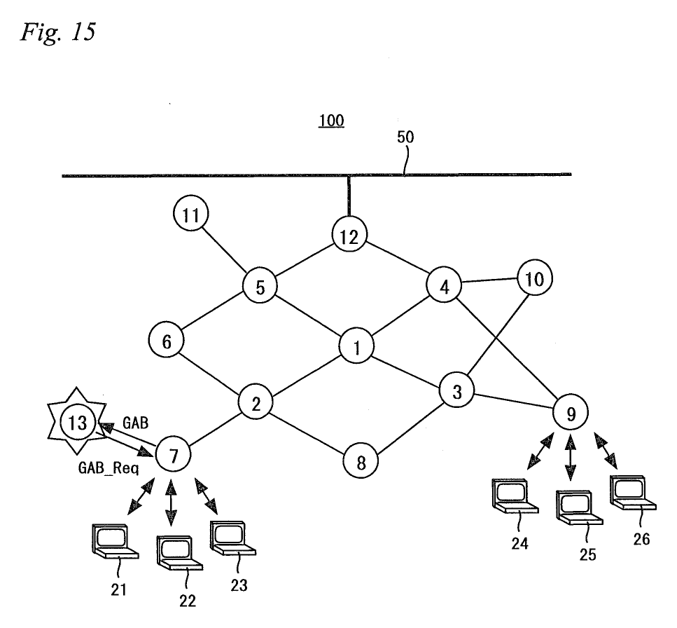

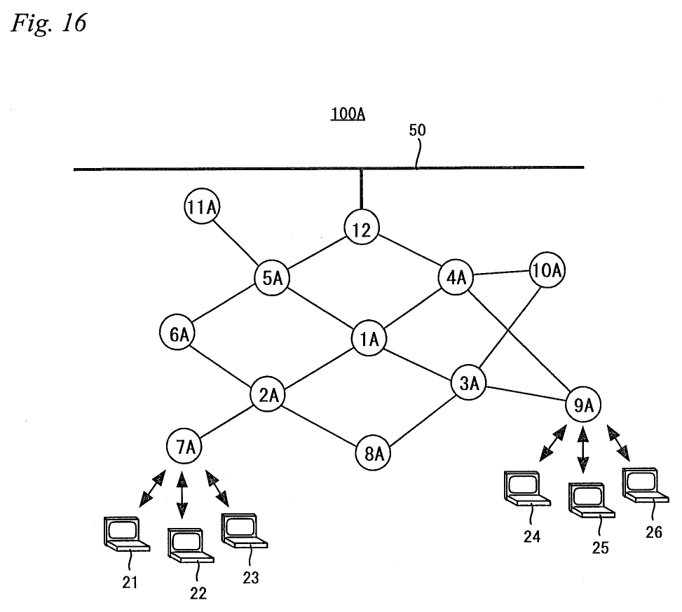

FIG. 15 is a diagram for use in illustrating load reducing method 3. With reference to FIG. 15, when the radio device 13 newly joins the radio communication system 100, the transmitting/receiving means 102 of the radio device 13 transmits a transmission request GAB_Req for the global terminal connection information 106 to the radio device 7 that is adjacent to the radio device 13.

Then, upon receiving the transmission request GAB_Req for the global terminal connection information 106 from the radio device 13, the transmitting/receiving means 102 of the radio device 7 transmits the global terminal connection information 106-1 (see FIG. 9), that it holds, to the radio device 13 in response to the transmission request GAB_Req. (Note that in FIG. 15, the global terminal connection information is denoted as “GAB”).

Then, the transmitting/receiving means 102 of the radio device 13 receives the global terminal connection information 106-1 from the radio device 7 and holds the received global terminal connection information 106-1.

In this way, according to load reducing method 3, when the radio device 13 has newly joined the radio communication system 100, the transmission request GAB_Req for the global terminal connection information 106 and the global terminal connection information 106 (GAB) are exchanged between the newly joined radio device 13 and the radio device 7 adjacent to the radio device 13. More specifically, the radio communication is carried out only between the radio device 7 and the radio device 13 in the radio communication system 100.

Therefore, when a new radio device joins the radio communication system, the load in the radio communication system 100 can be reduced as compared to the case in which all the existing radio devices transmit local terminal connection information according to FDM to the newly joined radio device.

The above-described load reducing methods 1 and 2 are equivalent to reducing load in radio communication when any of the terminal devices subordinate to the radio devices 1 to 12 changes and the change is broadcast to the other radio devices, and the above-described load reducing method 3 is equivalent to reducing load in radio communication when the radio device 13 that has newly joined the radio communication system 100 obtains the global terminal connection information 106 of the entire radio communication system 100.

Change in any of the terminal devices subordinate to the radio devices 1 to 12 as well as new addition of the radio device 13 to the radio communication system 100 is equivalent to change in the topology of the radio communication system 100.

Therefore, in general, the load reducing method according to the first embodiment may be any reducing method as long as change in the topology of the radio communication system 100 if any is transmitted/received by minimum necessary communication.

Note that according to the first embodiment, the radio devices 1 to 12 form “a plurality of radio devices,” the radio device 7 forms “a first radio device” and the radio devices 1 to 6 and 8 to 12 form “n second radio devices (n: positive integer).”

The radio device 13 forms “a first radio device,” and the radio device 7 forms “a second radio device.”

### Second Embodiment

FIG. 16 is a schematic diagram of a radio communication system according to a second embodiment of the invention. With reference to FIG. 16, a radio communication system 100A according to the second embodiment has the same structure as that of the radio communication system 100 with the difference being that the radio devices 1 to 11 in the radio communication system 100 shown in FIG. 1 are replaced by radio devices 1A to 11A. According to the second embodiment, the terminal devices 21 to 23 belong to the radio device 7A and the terminals 24 to 26 belong to a terminal device 9A. Note that there are also terminal devices that belong to the radio devices 1A to 6A, 8A, 10A, 11A, and 12 though not shown in FIG. 16.

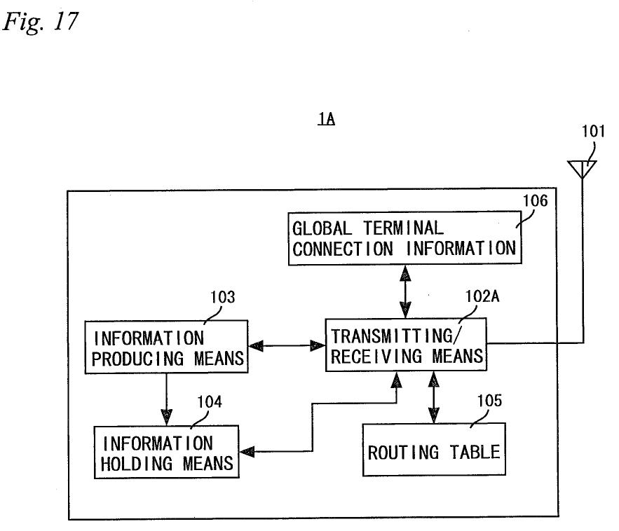

FIG. 17 is a schematic diagram of the configuration of the radio device 1A shown in FIG. 16. With reference to FIG. 17, the radio device 1A has the same structure as that of the radio device 1 with the difference being that the transmitting/receiving means 102 and the global terminal connection information 106 of the radio device 1 in FIG. 2 are replaced by a transmitting/receiving means 102A and terminal connection information 106A, respectively.

Similarly to the transmitting/receiving means 102, the transmitting/receiving means 102A produces local terminal connection information LAB representing the connection between the radio device 1A and terminal devices belonging to the radio device 1A. The transmitting/receiving means 102A transmits the produced local terminal connection information LAB to the radio device 12 as the root node by unicast.

The transmitting/receiving means 102A produces terminal connection information 106A based on the local terminal connection information LAB it has produced and the local terminal connection information LAB received from the other radio devices. Other than the above, the transmitting/receiving means 102A functions in the same manner as the transmitting/receiving means 102 does.

The terminal connection information 106A has the same structure as that of the global terminal connection information 106 (see FIG. 4) and has less connection information than that of the global terminal connection information 106. More specifically, the terminal connection information 106A does not consist of the connection information among the radio devices and the terminal devices in the entire radio communication system 100A but of the local terminal connection information LAB produced in the radio device 1A and the local terminal connection information LAB produced by part of the radio devices 2A to 11A and 12.

Note that the radio devices 2A to 11A each have the same configuration as that of the radio device 1A shown in FIG. 17.

In the radio communication system 100A, the radio devices 1A to 11A do not have the global terminal connection information 106 and only the radio device 12 as the root node has the global terminal connection information 106.

When the radio device 12 as the root node forms the global terminal connection information 106, the radio devices 1A to 11A each transmit local terminal connection information LAB produced by each radio device to the radio device 12 (root node) by unicast.

In this way, the transmitting/receiving means 102 of the radio device 12 (root node) receives the plurality of pieces of the local terminal connection information LAB transmitted by unicast from the radio devices 1A to 11A and produces the global terminal connection information 106 based on the local terminal connection information LAB it has produced and the plurality of pieces of local terminal connection information LAB received from the radio devices 1A to 11A.

In this case, the transmitting/receiving means 102A of any radio device existing on the route along which the radio devices 1A to 11A each transmit the local terminal connection information LAB to the radio device 12 (root node) registers the local terminal connection information LAB produced by the other radio devices when the transmitting/receiving means 102A relays the local terminal connection information LAB produced by the other radio devices to the radio device 12 (root node). In this way, the transmitting/receiving means 102A of each of the radio devices 1A to 11A can produce the terminal connection information 106A in the process in which the radio device 12 (root node) produces the global terminal connection information 106.

Now, a load reducing method in the above-described radio communication system 100A will be described.

Reducing Method 4

In load reducing method 4, upon receiving a packet from a terminal device subordinate to them, the radio devices 1A to 11A each transmit the packet to the destination terminal device via the radio device 12 as the root node if which radio device the destination terminal device belongs to is unknown.

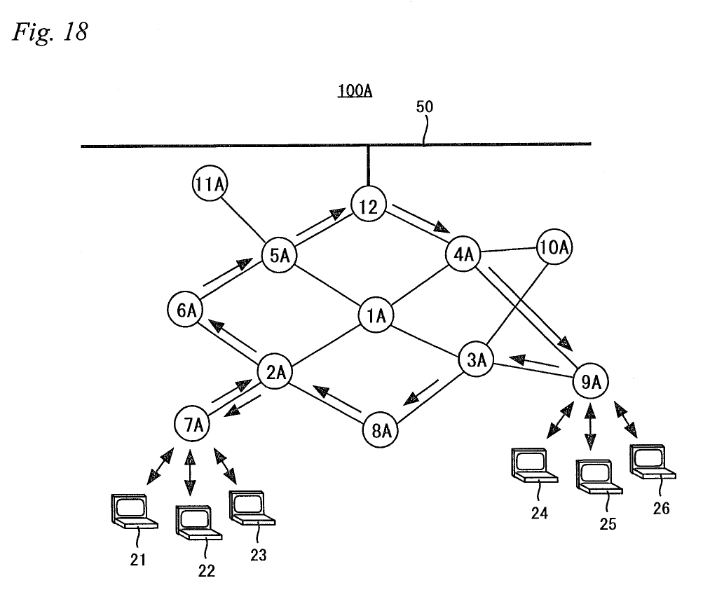

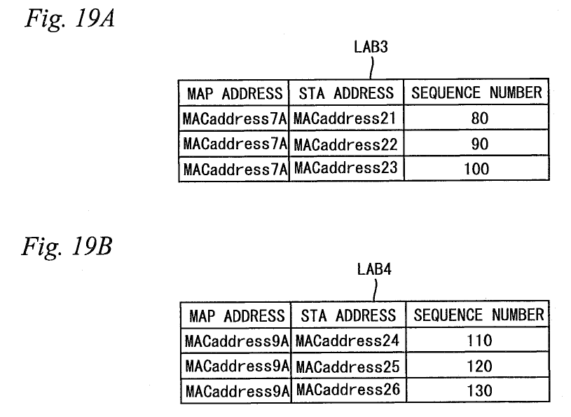

FIG. 18 is a diagram for use in illustrating load reducing method 4. FIGS. 19A and 19B are diagrams showing other examples of local terminal connection information. Referring to FIG. 18, load reducing method 4 will be described with reference to an example of how packets are exchanged between the terminal device 21 subordinate to the radio device 7A and the terminal device 24 subordinate to the radio device 9A. In this case, the radio device 7A holds terminal connection information 106A including local terminal connection information LAB3 (see FIG. 19A) and the radio device 9A holds terminal connection information 106A including local terminal connection information LAB4 (see FIG. 19B).

With reference to FIG. 18, upon receiving a packet PKT destined to the terminal device 24 subordinate to the radio device 9A from its own subordinate terminal device 21, the transmitting/receiving means 102A of the radio device 7A determines whether terminal connection information 106A (the local terminal connection information LAB3) includes information representing the connection between the destination terminal device 24 and the radio device 9A to which the destination terminal device 24 belongs.

Upon determining that the information representing the connection between the terminal device 24 and the radio device 9A is not included in the terminal connection information 106A (the local terminal connection information LAB3), the transmitting/receiving means 102A of the radio device 7A refers to the routing table 105 to determine the route from the radio device 7A via the radio device 2A, the radio device 6A, and the radio device 5A to the radio device 12 as the route along which the packet PKT received from its subordinate terminal device and the local terminal connection information LAB3 it has produced are to be transmitted to the radio device 12 (root node) and transmits the packet PKT and the local terminal connection information LAB3 along the determined route. In this case, the transmitting/receiving means 102A of each of the radio devices 2A, 6A, and 5A relays the packet PKT and the local terminal connection information LAB3.

The transmitting/receiving means 102 of the radio device 12 (root node) receives the packet PKT and the local terminal connection information LAB3, detects the terminal device 24 as the destination by referring to the header of the received packet PKT, and detects the radio device 9A to which the detected terminal device 24 belongs by referring to the global terminal connection information 106.

In this way, the transmitting/receiving means 102 of radio device 12 (root node) refers to the routing table 105 to determine the route from the radio device 12 via the radio device 4A to the radio device 9A as the route along which the packet PKT and the local terminal connection information LAB3 are to be transmitted to the radio device 9A and transmits the packet PKT and the local terminal connection information LAB3 along the determined route. In this case, the transmitting/receiving means 102A of the radio device 4A relays the packet PKT and the local terminal connection information LAB3.

The transmitting/receiving means 102A of the radio device 9A receives the packet PKT and the local terminal connection information LAB3 and registers the received local terminal connection information LAB3 in the terminal connection information 106A. The transmitting/receiving means 102A of the radio device 9A refers to the header of the received packet PKT to detect the terminal device 24 as the destination of the packet PKT. Thereafter, the transmitting/receiving means 102A of the radio device 9A refers to the local terminal connection information LAB4 (see FIG. 19B) it has produced, detects the terminal device 24 as a terminal device subordinate to the radio device 9A and transmits the packet PKT to the terminal device 24. The terminal device 24 receives the packet PKT transmitted from the terminal device 21.

Upon receiving the packet PKT transmitted from the terminal device 21, the terminal device 24 produces a packet PKT destined to the terminal device 21 and transmits the produced packet PKT to the radio device 9A.

The transmitting/receiving means 102A of the radio device 9A receives the packet PKT from the terminal device 24, refers to the header of the received packet PKT and detects the terminal device 21 as the destination of the packet PKT. The transmitting/receiving means 102A of the radio device 9A refers to the terminal connection information 106A to determine that the terminal device 21 belongs to the radio device 7A. Then, the transmitting/receiving means 102A of the radio device 9A refers to the routing table 105 to determine the route from the radio device 9A via the radio device 3A, the radio device 8A, and the radio device 2A to the radio device 7A as the route along which the packet PKT and the local terminal connection information LAB4 it has produced are to be transmitted to the radio device 7A and transmits the packet PKT and the local terminal connection information LAB4 along the determined route. In this case, the radio devices 3A, 8A, and 2A relay the packet PKT and the local terminal connection information LAB4.

The transmitting/receiving means 102A of the radio device 7A receives the packet PKT and the local terminal connection information LAB4 and registers the received local terminal connection information LAB4 in the terminal connection information 106A. The transmitting/receiving means 102A of the radio device 7A refers to the header of the received packet PKT to detect the terminal device 21 as the destination of the packet PKT. The transmitting/receiving means 102A of the radio device 7A then refers to the terminal connection information 106A to detect the terminal device 21 as a terminal device subordinate to the radio device 7A and transmits the packet PKT to the terminal device 21. The terminal device 21 receives the packet PKT transmitted from the terminal device 24.

When the packet PKT is exchanged once between the terminal device 21 and the terminal device 24, the radio device 7A holds the terminal connection information 106A including the local terminal connection information LAB4, and the radio device 9A holds the terminal connection information 106A including the local terminal connection information LAB3. Thereafter, the terminal device 21 and the terminal device 24 exchange packets PKT between each other through the route from the radio device 7A via the radio device 2A, the radio device 8A, and the radio device 3A to the radio device 9A.

When the packet PKT is transmitted from the terminal device 24 to the terminal device 21, the transmitting/receiving means 102A of each of the radio devices 3A, 8A, and 2A that relays the packet PKT and the local terminal connection information LAB4 may register the local terminal connection information LAB4 in the terminal connection information 106A.

The transmitting/receiving means 102A of each of the radio devices 2A, 6A, 5A, and 4A that relays the packet PKT and the local terminal connection information LAB3 may register the local terminal connection information LAB3 in the terminal connection information 106A.

Furthermore, when the radio device 7A receives the packet PKT from the terminal device 21 for the first time and holds the terminal connection information 106A including the local terminal connection information LAB4, the radio device 7A transmits the packet PKT and its own local terminal connection information LAB3 to the radio device 9A along the route from the radio device 7A via the radio device 2A, the radio device 8A, and the radio device 3A to the radio device 9A.

Furthermore, the above load reducing method 4 is described with reference to the example in which packets are exchanged between the terminal device 21 subordinate to the radio device 7A and the terminal device 24 subordinate to the radio device 9A, while radio communication is similarly carried out by the above-described method when packets are exchanged between two terminal devices subordinate to two different radio devices other than the radio devices 7A and 9A.

As described above, according to load reducing method 4, when the radio device 7A receives the packet PKT from the terminal device 21 and the radio device to which the terminal device 24 as the destination of the packet PKT cannot be detected, the radio device 7A transmits the packet PKT to the destination terminal device 24 via the radio device 12 (root node) holding the global terminal connection information 106.

Load Reducing Method 5

According to load reducing method 5, when the radio devices 1A to 11A each receive a packet from any of their subordinate terminal devices and it is unknown which radio device the terminal device as the destination of the received packet belongs to, they make an inquiry to the radio device 12 as the root node about the radio device to which the destination terminal device belongs and transmits the packet to the destination terminal device.

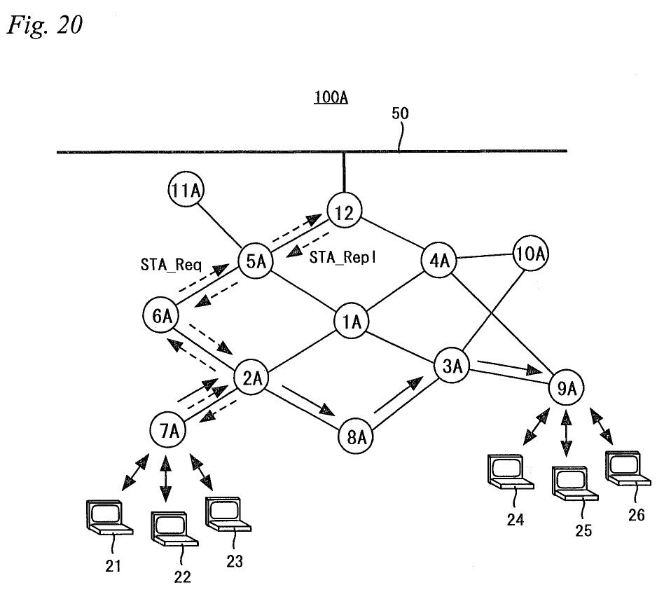

FIG. 20 is a diagram for use in illustrating load reducing method 5. As shown FIG. 20, load reducing method 5 will be described by referring to an example of how packets are exchanged between the terminal device 21 subordinate to the radio device 7A and the terminal device 24 subordinate to the radio device 9A.

With reference to FIG. 20, upon receiving a packet PKT destined to the terminal device 24 subordinate to the radio device 9A from its own subordinate terminal device 21, the transmitting/receiving means 102A of the radio device 7A determines whether the terminal connection information 106A includes information representing the connection between the destination terminal device 24 and the radio device 9A to which the destination terminal device 24 belongs.

Upon determining that the terminal connection information 106A does not include the information representing the connection between the terminal device 24 and the radio device 9A, the transmitting/receiving means 102A of the radio device 7A produces a transmission request STA_Req for the local terminal connection information LAB4 (see FIG. 19B) and transmits the transmission request STA_Req by unicast to the radio device 12 (root node). Note that in FIG. 20, the dotted line along the route from the radio device 7A via the radio device 2A, the radio device 6A, and the radio device 5A to the radio device 12 represents the flow of the transmission request STA_Req.

Upon receiving the transmission request STA_Req for the local terminal connection information LAB4, the transmitting/receiving means 102 of the radio device 12 (root node) extracts the local terminal connection information LAB4 from the global terminal connection information 106 and transmits a response STA_Repl including the extracted local terminal connection information LAB4 to the radio device 7A by unicast via the radio devices 5A, 6A, and 2A. In this case, the transmitting/receiving means 102A of each of the radio devices 5A, 6A, and 2A that relays the response STA_Repl extracts the local terminal connection information LAB4 included in the response STA_Repl and registers the information in the terminal connection information 106A. Note that in FIG. 20, the dotted line along the route from the radio device 12 via the radio device 5A, the radio device 6A, and the radio device 2A to the radio device 7A represents the flow of the response STA_Repl.

The transmitting/receiving means 102A of the radio device 7A receives the response STA_Repl, extracts the local terminal connection information LAB4 included in the received response STA_Repl and registers the information in the terminal connection information 106A.

Then, the transmitting/receiving means 102A of the radio device 7A can determine that the terminal device 24 that is the destination of the packet PKT received from the terminal device 21 belongs to the radio device 9A by referring to the terminal connection information 106A, therefore refers to the routing table 105 to determine the route from the radio device 7A via the radio device 2A, the radio device 8A, and the radio device 3A to the radio device 9A as the route along which the packet PKT and the local terminal connection information LAB3 it has produced are to be transmitted to the radio device 9A and transmits the packet PKT and the local terminal connection information LAB3 along the determined route to the radio device 9A. Note that the solid arrow in FIG. 20 represents the flow of the packet PKT and the local terminal connection information LAB (or packet PKT).

In this case, the radio devices 2A, 8A, and 3A relay the packet PKT and the local terminal connection information LAB3, and therefore the transmitting/receiving means 102A of the radio devices 2A, 8A, and 3A may register the local terminal connection information LAB3 in the terminal connection information 106A.

The transmitting/receiving means 102A of the radio device 9A receives the packet PKT and the local terminal connection information LAB3 and registers the received local terminal connection information LAB3 in the terminal connection information 106A. The transmitting/receiving means 102A of the radio device 9A detects the terminal device 24 as the destination of the packet PKT by referring to the header of the received packet PKT. Then, the transmitting/receiving means 102A of the radio device 9A detects the terminal device 24 as a terminal device subordinate to the radio device 9A by referring to the terminal connection information 106A and transmits the packet PKT to the terminal device 24. The terminal device 24 then receives the packet PKT transmitted from the terminal device 21.

Upon receiving the packet PKT transmitted from the terminal device 21, the terminal device 24 produces a packet PKT destined to the terminal device 21 and transmits the produced packet to the radio device 9A.

The transmitting/receiving means 102A of the radio device 9A receives the packet PKT from the terminal device 24 and refers to the header of the received packet PKT to detect the terminal device 21 as the destination of the packet PKT. The transmitting/receiving means 102A of the radio device 9A determines that the terminal device 21 belongs to the radio device 7A by referring to the terminal connection information 106A. Then, the transmitting/receiving means 102A of the radio device 9A refers to the routing table 105 to determine the route from the radio device 9A via the radio device 3A, the radio device 8A, and the radio device 2A to the radio device 7A as the route along which the packet PKT is to be transmitted to the radio device 7A, and transmits the packet PKT along the determined route.

The transmitting/receiving means 102A of the radio device 7A receives the packet PKT, and refers to the header of the packet PKT to detect the terminal device 21 as the destination of the packet PKT. Thereafter, the transmitting/receiving means 102A of the radio device 7A refers to the terminal connection information 106A to detect the terminal device 21 as a terminal device subordinate to the radio device 7A, and transmits the packet PKT to the terminal device 21. The terminal device 21 then receives the packet PKT transmitted from the terminal device 24.

When the packet PKT is transmitted from the terminal device 21 to the terminal device 24 once, the radio device 7A holds the terminal connection information 106A including the local terminal connection information LAB4, and the radio device 9A holds the terminal connection information 106A including the local terminal connection information LAB3. Thereafter, the terminal device 21 and terminal device 24 exchange packets PKT between each other through the route from the radio device 7A via the radio device 2A, the radio device 8A, and the radio device 3A to the radio device 9A.

Note that when the radio device 7A receives the packet PKT from the terminal device 21 for the first time and holds the terminal connection information 106A including the local terminal connection information LAB4, the radio device 7A transmits the packet PKT and its local terminal connection information LAB3 to the radio device 9A along the route from the radio device 7A via the radio device 2A, the radio device 8A, and the radio device 3A to the radio device 9A.

The above load reducing method 5 is described with reference to the example in which packets are exchanged between the terminal device 21 subordinate to the radio device 7A and the terminal device 24 subordinate to the radio device 9A, while the radio communication is similarly carried out by the above-described method when packets are exchanged between two terminal devices subordinate to two different radio devices other than the radio devices 7A and 9A.

As described above, according to load reducing method 5, when the radio device 7A receives the packet PKT from the terminal device 21 and cannot detect which radio device the terminal device 24 as the destination of the packet PKT belongs to, the radio device 7A obtains information related to the radio device 9A to which the destination terminal device 24 belongs (the local terminal connection information LAB4) from the radio device 12 (root node) that holds the global terminal connection information 106 and transmits the packet PKT accordingly.

According to the above-described load reducing methods 3 and 4, when the radio device 7A receives the packet PKT from the source terminal device and where the terminal device as the destination of the packet PKT belongs is unknown, the radio device 7A transmits the packet PKT via the radio device 12 as the root node to the destination terminal device 24 or obtains information related to the radio device 9A to which the terminal device belongs from the radio device 12 as the root node and then transmits the packet PKT to the destination terminal device 24.

Therefore, in general, the load reducing method according to the second embodiment may be any method that allows a packet PKT to transmitted to its destination with the aid of the radio device 12 as the root node when the radio device 7A that has received the packet PKT from the source terminal device does not know which device the terminal device as the destination of the packet PKT belongs to.

As in the foregoing, according to the second embodiment, when the radio device 12 as the root node constructs the global terminal connection information 106 in the entire radio communication system 100A, the radio devices 1A to 11A transmit local terminal connection information LAB they have produced to the radio device 12 by unicast, and therefore the load during constructing the global terminal connection information 106 in the radio device 12 (root node) can be reduced. Consequently, the load in the radio communication system 100A can be reduced.

According to the second embodiment, only the radio device 12 as the root node holds the global terminal connection information 106 in the entire radio communication system 100A and therefore the load in the radio communication system 100A can be reduced.

Furthermore, according to the second embodiment, the transmission request STA_Req for the local terminal connection information LAB and the response STA_Repl to the transmission request STA_Req are transmitted by unicast, and therefore the load in the radio communication system 100A can be reduced.

Note that according to the second embodiment, the radio device 7A forms a “first radio device,” the radio device 9A forms a “second radio device,” and the radio device 12 forms a “third radio device.”

The terminal device 21 forms a “first terminal device” and the terminal device 24 forms a “second terminal device.”

### Third Embodiment

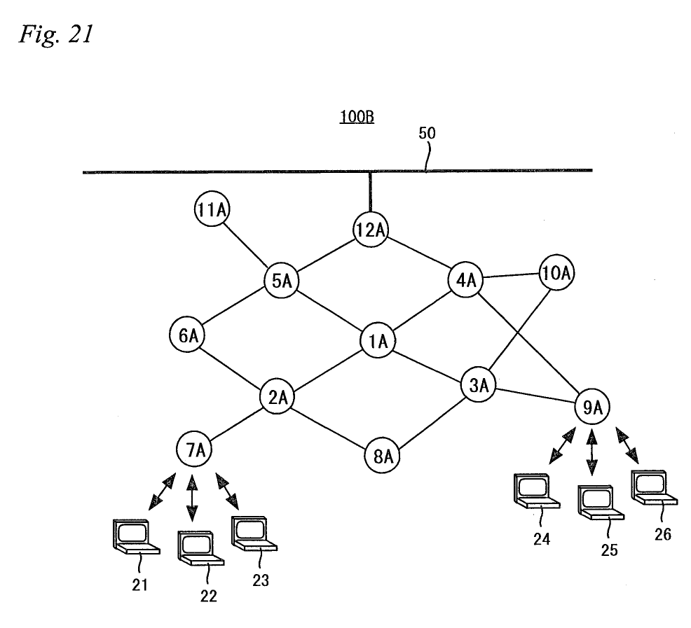

FIG. 21 is a schematic diagram of a radio communication system according to a third embodiment of the invention. With reference to FIG. 21, the radio communication system 100B according to the third embodiment has the same configuration as that of the radio communication system 100A shown in FIG. 16 with the difference being that the radio device 12 is replaced by the radio device 12A. The radio device 12A has the same configuration as that of the radio device 1A shown in FIG. 17.

Therefore, in the radio communication system 100B, the radio devices 1A to 12A do not hold the global terminal connection information 106 representing the connection between the radio devices and the terminal devices in the entire radio communication system 100B but the terminal connection information 106A. More specifically, the radio devices 1A to 12A each hold terminal connection information 106A including local terminal connection information LAB, they have produced, at the initial stage.

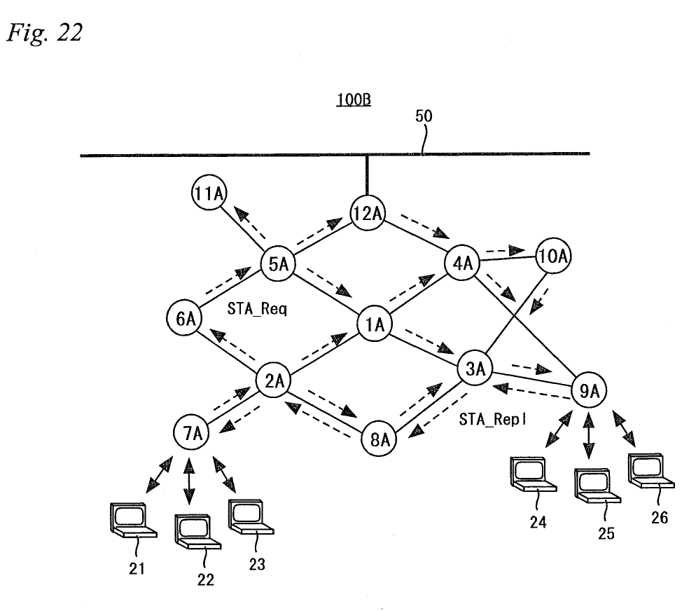

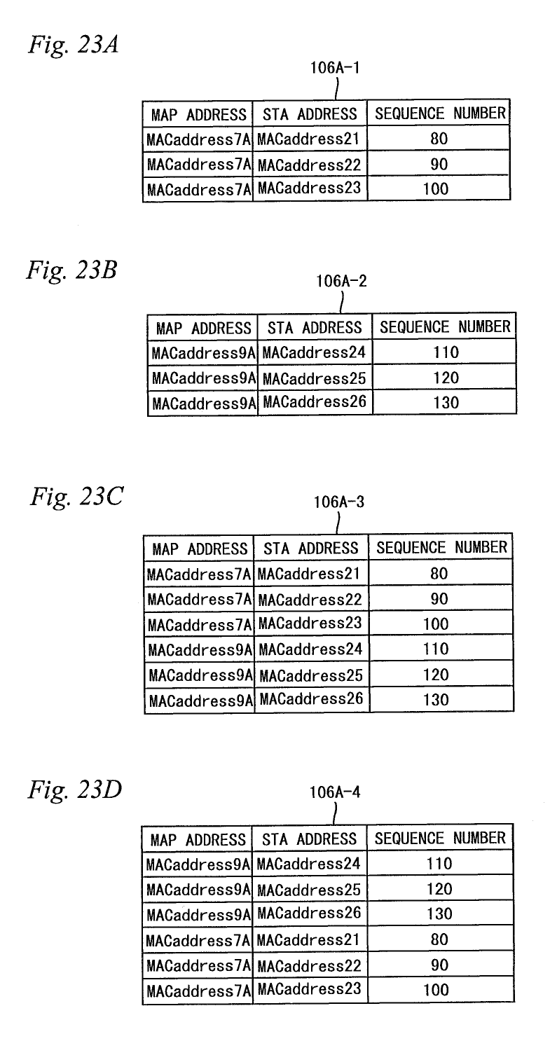

FIG. 22 is a diagram for use in illustrating a communication method in the radio communication system 100B shown in FIG. 21. FIGS. 23A to 23D are diagrams showing examples of the terminal connection information 106A.

With reference to FIG. 22, the radio device 7A holds terminal connection information 106A-1 (see FIG. 23A) representing the connection between its subordinate terminal devices 21 to 23 and itself to start with, and the radio device 9A holds terminal connection information 106A-2 (see FIG. 23B) representing the connection between its subordinate terminal devices 24 to 26 and itself to start with.

Upon receiving a packet PKT destined to the terminal device 24 from the terminal device 21 as the source, the transmitting/receiving means 102A of the radio device 7A refers to the header of the received packet PKT to detect the terminal device 24 as the destination of the packet PKT.

The transmitting/receiving means 102A of the radio device 7A then searches for a radio device to which the terminal device 24 belongs by referring to the terminal connection information 106A-1 but cannot detect the radio device to which the terminal device 24 belongs because the terminal connection information 106A-1 does not include the MAC address of the terminal device 24.

The transmitting/receiving means 102 of the radio device 7A produces a transmission request STA_Req for information related to the radio device to which the terminal device 24 belongs and floods the produced transmission request STA_Req in the radio communication system 100B.

Then, the transmitting/receiving means 102A of the radio device 9A to which the destination terminal device 24 belongs receives the transmission request STA_Req transmitted from the radio device 7A and produces a response STA_Repl including the terminal connection information LAB4 (see FIG. 19B) in response to the transmission request STA_Req. The transmitting/receiving means 102A of the radio device 9A refers to the routing table 105 to determine the route from the radio device 9A via the radio device 3A, the radio device 8A, and the radio device 2A to the radio device 7A as the route along which the response STA_Repl is to be transmitted to the radio device 7A, and transmits the response STA_Repl to the radio device 7A along the determined route by unicast.

In this case, the transmitting/receiving means 102A of each of the radio devices 3A, 8A, and 2A relays the response STA_Repl and therefore the local terminal connection information LAB4 included in the response STA_Repl may be registered in the terminal connection information 106A of the radio devices 3A, 8A, and 2A.

The transmitting/receiving means 102A of the radio device 7A receives the response STA_Repl transmitted from the radio device 9A, extracts the local terminal connection information LAB4 from the received response STA_Repl, and registers it in the terminal connection information 106A-1 to update the terminal connection information 106A-1 to terminal connection information 106A-3 (see FIG. 23C).

The transmitting/receiving means 102A of the radio device 7A refers to the terminal connection information 106A-3 to determine that the terminal device 24 as the destination of the packet PKT belongs to the radio device 9A. The transmitting/receiving means 102A of the radio device 7A refers to the routing table 105 to determine the route from the radio device 7A via the radio device 2A, the radio device 8A, and the radio device 3A to the radio device 9A as the route along which the packet PKT and the local terminal connection information LAB3 it has produced (see FIG. 19A) are to be transmitted to the radio device 9A and transmits the packet PKT and the local terminal connection information LAB3 to the radio device 9A along the determined route.

In this case, the transmitting/receiving means 102A of each of the radio devices 2A, 8A, and 3A relays the packet PKT and the local terminal connection information LAB3 and therefore the local terminal connection information LAB3 may be registered in the terminal connection information 106A of the radio devices 3A, 8A, and 2A.

The transmitting/receiving means 102A of the radio device 9A receives the packet PKT and the local terminal connection information LAB3 transmitted from the radio device 7A and registers the received local terminal connection information LAB3 in the terminal connection information 106A-2 to update the terminal connection information 106A-2 to terminal connection information 106A-4 (see FIG. 23D). The transmitting/receiving means 102A of the radio device 9A refers to the header of the received packet PKT to detect the terminal device 24 as the destination of the packet PKT and transmits the packet PKT to the terminal device 24. The terminal device 24 receives the packet PKT transmitted from the terminal device 21.

Upon receiving the packet PKT from the terminal device 21, the terminal device 24 produces a packet PKT destined to the terminal device 21 and transmits the packet PKT to the radio device 9A.

Upon receiving the packet PKT from the terminal device 24, the transmitting/receiving means 102A of the radio device 9A refers to the header of the received packet PKT to detect the terminal device 21 as the destination of the packet PKT. The transmitting/receiving means 102A of the radio device 9A refers to the terminal connection information 106A-4 to determine that the destination terminal device 21 belongs to the radio device 7A.

Then, the transmitting/receiving means 102A of the radio device 9A refers to the routing table 105 to determine the route from the radio device 9A via the radio device 3A, the radio device 8A, and the radio device 2A to the radio device 7A as the route along which the packet PKT is to be transmitted and transmits the packet PKT along the determined route.

The radio devices 3A, 8A, and 2A relay the packet PKT and the radio device 7A receives the packet PKT. The transmitting/receiving means 102A of the radio device 7A refers to the header of the packet PKT to detect the terminal device 21 as the destination of the packet PKT and the transmits the received packet PKT to the terminal device 21. In this way, the terminal device 21 receives the packet PKT transmitted from the terminal device 24.

When the radio device 7A receives the packet PKT from the terminal device 21 and knows the radio device 9A to which the radio device 24 as the destination of the packet PKT belongs, it transmits the packet PKT and the local terminal connection information LAB3 to the radio device 9A without flooding the transmission request STA_Req.

Radio communication is carried out between two terminal devices that belong to two different radio devices other than the radio devices 7A and 9A by the above-described method.

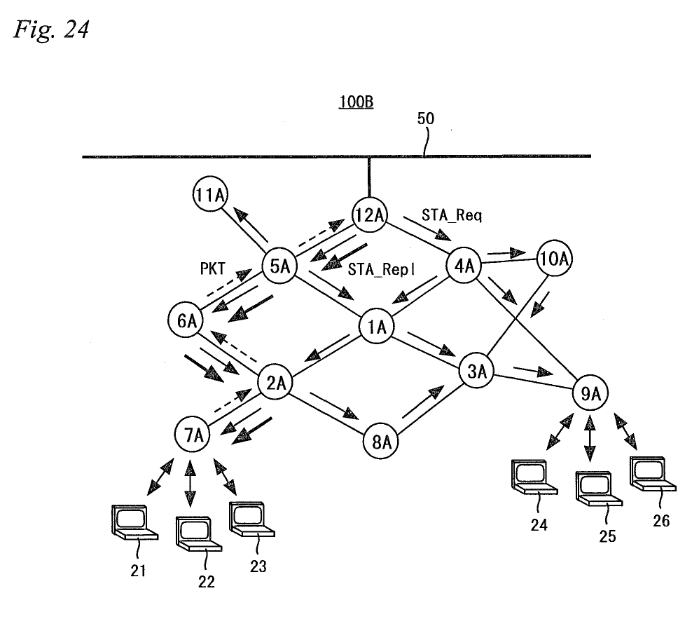

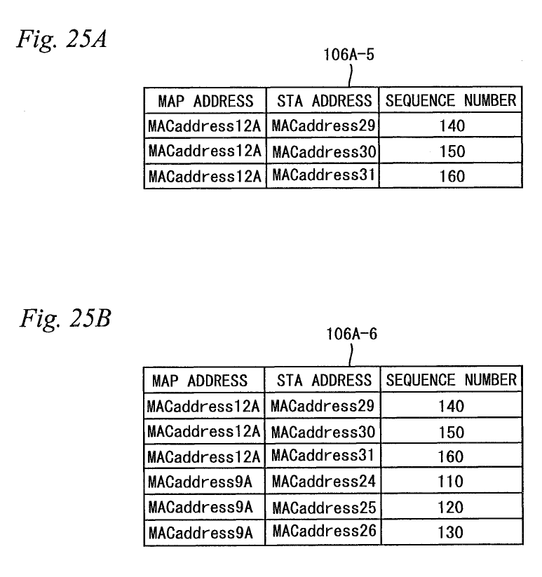

FIG. 24 is a diagram for use in illustrating another communication method in the radio communication system 100B shown in FIG. 21. FIGS. 25A and 25B are diagrams showing other examples of the terminal connection information 106A.

With reference to FIG. 24, to start with, the radio device 7A holds the terminal connection information 106A-1 (see FIG. 23A) representing the connection between its subordinate terminal devices 21 to 23 and itself, the radio device 9A holds the terminal connection information 106A-2 (see FIG. 23B) representing the connection between its subordinate terminal devices 24 to 26 and itself to start with and the radio device 12A holds terminal connection information 106A-5 (see FIG. 25A) representing the connection between its subordinate terminal devices 29 to 31 and itself to start with.

Upon receiving a packet PKT destined to the terminal device 24 from the terminal device 21 as the source, the transmitting/receiving means 102A of the radio device 7A refers to the header of the received packet PKT to detect the terminal device 24 as the destination of the packet PKT.

Then, the transmitting/receiving means 102A of the radio device 7A refers to the terminal connection information 106A-1 to search for a radio device to which the terminal device 24 belongs but cannot detect the radio device to which the terminal device 24 belongs because the terminal connection information 106A-1 does not include the MAC address of the terminal device 24.

The transmitting/receiving means 102A of the radio device 7A therefore transmits the packet PKT received from the terminal device 21 to the radio device 12A as the root node by unicast. Note that in FIG. 24, the dotted line arrow represents the flow of the packet PKT.

The transmitting/receiving means 102A of the radio device 12A (root node) receives the packet PKT from the radio device 7A and refers to the header of the received packet PKT to detect the terminal device 24 as the destination of the packet PKT. The transmitting/receiving means 102A of the radio device 12A (root node) determines that the local terminal connection information LAB4 (see FIG. 19B) is not included in the terminal connection information 106A-5, produces a transmission request STA_Req for information related to the radio device to which the terminal device 24 belongs, and floods the produced transmission request STA_Req in the radio communication system 100B. Note that in FIG. 24, the solid line arrow represents the flow of the transmission request STA_Req.

Then, the transmitting/receiving means 102A of one of the radio devices 2A to 6A and 8A to 11A receives the transmission request STA_Req transmitted from the radio device 12A (root node) and produces a response STA_Repl including the local terminal connection information LAB4 (see FIG. 19B) in response to the received transmission request STA_Req. The transmitting/receiving means 102A of one of the radio devices 2A to 6A and 8A to 11A refers to the routing table 105 to determine the route along which the response STA_Repl is to be transmitted to the radio device 12A (root node) and transmits the response STA_Repl along the determined route to the radio device 12A (root node) by unicast.

In this case, the transmitting/receiving means 102A of any radio device existing along the route from any of the radio devices 2A to 6A and 8A to 11A to the radio device 12A relays the response STA_Repl and therefore may register the local terminal connection information LAB4 included in the response STA_Repl in its own terminal connection information 106A.

The transmitting/receiving means 102A of the radio device 12A (root node) receives the response STA_Repl transmitted from one of the radio devices 2A to 6A and 8A to 11A, extracts the local terminal connection information LAB4 from the receive response STA_Repl, registers the extracted information in the terminal connection information 106A-5 of the radio device 12A and updates the terminal connection information 106A-5 to terminal connection information 106A-6 (see FIG. 25B).

Then, the transmitting/receiving means 102A of the radio device 12A (root node) refers to the terminal connection information 106A-6 to determine that the terminal device 24 as the destination of the packet PKT belongs to the radio device 9A. The transmitting/receiving means 102A of the radio device 12A (root node) produces a response STA_repl including the local terminal connection information LAB4, refers to the routing table 105 and determines the route from the radio device 12A via the radio device 5A, the radio device 6A, and the radio device 2A to the radio device 7A as the route along which the produced response STA_repl is to be transmitted to the radio device 7A, and transmits the response STA_repl along the determined route to the radio device 7A by unicast. Note that the thick solid line arrow represents the flow of the STA_repl.

In this case, the transmitting/receiving means 102A of each of the radio devices 5A, 6A, and 2A relays the response STA_repl and therefore may register the local terminal connection information LAB4 included in the response STA_repl in its own terminal connection information 106A.

The transmitting/receiving means 102A of the radio device 7A receives the response STA_repl, detects the local terminal connection information LAB4 included in the received response STA_repl, registers the detected information in the terminal connection information 106A-1 (see FIG. 23A) and updates the terminal connection information 106A-1 to the terminal connection information 106A-3 (see FIG. 23B).

Then, the radio devices 7A and 9A carry out radio communication with each other according to the communication method described in conjunction with FIGS. 22 and 23A to 23D. In this way, the terminal devices 21 and 24 can carry out radio communication with each other.

In this way, the radio device 12A (root node) constructs the terminal connection information 106-A in response to a transmission request for a packet PKT from the radio device 7A, in other words, in response to a need, and aids radio communication between the radio devices 7A and 9A.

As described above, according to the third embodiment, when the radio device 7A receives a packet PKT from the source terminal device 21 and does no know the radio device to which the terminal device 24 as the destination of the packet PKT belongs (the radio device 9A), the radio device 7A obtains the local terminal connection information LAB4 representing the connection between the radio device 9A and the terminal devices 24 to 26 to construct the terminal connection information 106A-3 and transmits the packet PKT to the radio device 9A. More specifically, the radio device 7A constructs the terminal connection information 106A-3 when necessary and transmits the packet PKT to the radio device 9A.

The radio device 9A then receives the local terminal connection information LAB3 in the radio device 7A simultaneously with the reception of the packet PKT from the radio device 7A and constructs the terminal connection information 106A-4.

Consequently, the terminal connection information 106A is constructed in a part of the radio communication system 100B. Therefore, according to the third embodiment, the load in the radio communication system 100B can be reduced.

When the radio device 7A constructs the terminal connection information 106A-3, the radio device 9A or 12A transmits the response STA_Repl to the radio device 7A by unicast and therefore the load in the radio communication system 100B can be reduced.

In the foregoing description, the radio device 7A receives the response STA_Repl from the radio device 9A or 12A, while according to the invention, if a radio device other than the radio devices 9A and 12A holds the local terminal connection information LAB4, the radio device 7A may obtain the response STA_Repl from such the radio device other than the radio devices 9A and 12A.

In general, the radio communication system according to the third embodiment needs only include a radio device that constructs the terminal connection information 106A as required and relays radio communication between a source terminal device and a destination terminal device. Consequently, in the radio communication system, minimum necessary terminal connection information is constructed and therefore the load in the radio communication system 100B can be reduced.

It is to be understood that the embodiments disclosed herein are illustrative and not restrictive. The scope of the invention is defined by the appended claims rather than by the description preceding them, and all modifications that fall within the scope of claims and equivalence thereof are intended to be embraced by the claims.

What is claimed is:

1. A radio communication system, comprising:
a first radio device;
a first terminal device connected with said first radio device;
a second radio device; and
a second terminal device connected with said second radio device,
said first and second radio devices constructing terminal connection information representing the connection between the radio devices and the terminal devices as required and relay radio communication between said first terminal device and said second terminal device.

2. The radio communication system according to claim 1, wherein upon receiving a packet destined to said second terminal device from said first terminal device, said first radio device obtains local terminal connection information representing the connection between said second radio device and said second terminal device, and relays said packet to said second radio device based on the obtained local terminal connection information,
said second radio device receives the packet relayed by said first radio device and transmits the received packet to said second terminal device, and
said second terminal device receives the packet transmitted from said second radio device.

3. The radio communication system according to claim 2, wherein upon receiving said packet from said first terminal device, said first radio device floods a terminal information request that requests transmission of said local terminal connection information and receives said local terminal connection information from said second radio device by unicast.

4. The radio communication system according to claim 2, further comprising a third radio device that relays radio communication between said first radio device and said second radio device, wherein
upon receiving said packet from said first terminal device, said first radio device floods a terminal information request that requests transmission of said local terminal connection information and receives said local terminal connection information from said third radio device by unicast.

5. A radio communication system including a plurality of radio devices each connected with at least one terminal device, comprising:
a first radio device that does not hold global terminal connection information representing the entire connection between the radio devices and the terminal devices in the radio communication system;
a first terminal device connected with said first radio device;
a second radio device that does not hold said global terminal connection information;
a second terminal device connected with said second radio device; and
a third radio device having said global terminal connection information, wherein
when said first radio device receives a packet destined to said second terminal device from said first terminal device and does not have first local terminal connection information representing the connection between said second terminal device and said second radio device, said first radio device transmits said packet to said second radio device with the aid of said third radio device,
said second radio device receives said packet and transmits the received packet to said second terminal device, and
said second terminal device receives said packet transmitted from said second radio device.

6. The radio communication system according to claim 5, wherein when said first radio device receives said packet from said first terminal device and does not have said first local terminal connection information, said first radio device transmits second local terminal connection information representing the connection between itself and said first terminal device and said packet to said third radio device,
said third radio device receives said second local terminal connection information and said packet, determines that said second terminal device to which the received packet is destined is connected with said second radio device based on said global terminal connection information and transmits said second local terminal connection information and said packet to said second radio device,
upon receiving said second local terminal connection information and said packet, said second radio device transmits said packet to said second terminal device, and
said second terminal device receives the packet transmitted from said second radio device.

7. The radio communication system according to claim 6, wherein upon receiving the packet destined to said first terminal device from said second terminal device, said second radio device transmits said first local terminal connection information and said packet to said first radio device,
upon receiving said first local terminal connection information and said packet, said first radio device transmits said received packet to said first terminal device, and
said first terminal device receives the packet transmitted from said first radio device.

8. The radio communication system according to claim 5, wherein when said first radio device receives said packet from said first terminal device and does not have said first local terminal connection information, said first radio device transmits a terminal information request that requests transmission of said first local terminal connection information to said third radio device by unicast,
upon receiving said first local terminal connection information from said third radio device, said first radio device transmits second local terminal connection information representing the connection between itself and said first terminal device and said packet to said second radio device,
upon receiving said terminal information request, said third radio device extracts said first local terminal connection information based on said global terminal connection information and transmits the extracted information to said first radio device and
said second radio device receives said second local terminal connection information and said packet and transmits said received packet to said second terminal device.

9. The radio communication system according to claim 7 or 8, wherein said first radio device further registers said first local terminal connection information in terminal connection information it holds, and
said second radio device further registers said second local terminal connection information in terminal connection information it holds.

10. The radio communication system according to claim 9, wherein when said first radio device obtains said first local terminal connection information and said second radio device obtains said second local terminal connection information, said first and second radio devices transmit/receive packets between each other without passing through said third radio device.

11. A radio communication system that allows a terminal device to carry out radio communication with another terminal device through a radio device, comprising a plurality of radio devices each connected with at least one terminal device and each having global terminal connection information representing the entire connection between the radio devices and the terminal devices in the radio communication system, wherein
when the topology in said radio communication system changes, said plurality of radio devices transmit/receive the change in said topology by minimum necessary communication.

12. The radio communication system according to claim 11, wherein when local terminal connection information held by each of said plurality of radio devices changes, said plurality of radio devices each flood only change information of said local terminal connection information.

13. The radio communication system according to claim 11, wherein said plurality of radio devices comprise:
a first radio device that has updated the connection with said terminal device; and
n (n: positive integer) second radio devices present around said first radio device, and
said n second radio devices transmit a connection information request that requests transmission of updated terminal connection information representing said updated connection to said first radio device sequentially in ascending order of distance from said first radio device.

14. The radio communication system according to claim 11, wherein said plurality of radio devices comprise:
a first radio device that has newly joined the radio communication system; and
a second radio device adjacent to said first radio device,
said first radio device requests said second radio device to transmit said global terminal connection information and receives said global terminal connection information from said second radio device, and
said second radio device transmits the global terminal connection information it holds to said first radio device in response to said request.
